(19) United States
(12) Patent Application Publication
(10) Pub. No.: US 2026/0163725 A1
(43) Pub. Date: Jun. 11, 2026

(54) COMPUTING SYSTEM AND METHOD WITH THRESHOLD ENCRYPTION

(71) Applicant: SmartContract Chainlink Limited SEZC, Grand Cayman (KY)

(72) Inventors: Lorenz BREIDENBACH, Grand Cayman (KY); Gregory NEVEN, Grand Cayman (KY); Pawel SZALACHOWSKI, Grand Cayman (KY); Dahlia Malkhi, Grand Cayman (KY)

(21) Appl. No.: 19/410,546

(22) Filed: Dec. 5, 2025

Related U.S. Application Data
(60) Provisional application No. 63/729,225, filed on Dec. 6, 2024.

(51) Int. Cl. H04L 9/08; H04L 9/30

(52) U.S. Cl. CPC H04L 9/085; H04L 9/3073

(57) ABSTRACT

A confidential computing system including a plurality of decryption nodes configured to collectively hold shares of a master secret key for a threshold encryption scheme, a plurality of oracle nodes configured to authenticate computation requests and assign the computation requests to compute enclaves, and a plurality of compute enclaves, each compute enclave comprising a trusted execution environment configured to execute computations on encrypted data. The plurality of decryption nodes are configured to generate encrypted decryption key shares for assigned compute enclaves based on encrypted inputs in the computation requests, such that each compute enclave receives decryption key shares for decrypting encrypted inputs assigned to that compute enclave. The plurality of oracle nodes are configured to verify attestations from the compute enclaves and provide attested responses.

### CROSS-REFERENCE TO RELATED APPLICATIONS

This application claims priority to U.S. Application No. 63/729,225 titled Trust-Minimized Confidential Computing as a Decentralized Service, filed on Dec. 6, 2024, the disclosure of which is hereby incorporated by reference in its entirety.

### FIELD OF INVENTION

The present disclosure relates to confidential computing systems for blockchain and decentralized applications, and more particularly to a system that combines trusted execution environments with threshold encryption to provide privacy-preserving computation while minimizing the impact of compromised components through strict data access controls.

### BACKGROUND

Blockchain networks and decentralized applications have gained widespread adoption for their ability to provide transparency, immutability, and decentralized consensus. However, these systems face inherent limitations when processing sensitive or confidential data, as traditional blockchain architectures require all transaction data and computational states to be publicly visible to network participants for verification purposes.

The transparency that makes blockchain networks trustworthy also creates privacy challenges for applications handling sensitive information such as financial data, personal information, or proprietary business logic. Many use cases that could benefit from blockchain technology remain impractical due to these privacy limitations, including private financial transactions, confidential smart contract execution, and secure multi-party computations.

Various approaches have been developed to address privacy concerns in blockchain systems. Zero-knowledge proofs enable verification of computations without revealing underlying data, but often suffer from high computational overhead and complexity in implementation. Secure multi-party computation protocols allow multiple parties to jointly compute functions over their inputs while keeping those inputs private, but typically require significant computational resources and communication overhead. Fully homomorphic encryption permits computations on encrypted data, but faces practical limitations in terms of performance and the types of operations that can be efficiently performed.

Trusted execution environments represent another approach to confidential computing, providing hardware-based isolation that protects code and data from unauthorized access. These environments can execute computations on sensitive data while maintaining confidentiality, but traditional implementations face challenges related to trust assumptions and potential vulnerabilities when individual components are compromised.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a confidential computing system is provided. The confidential computing system comprises a plurality of decryption nodes configured to collectively hold shares of a master secret key for a threshold encryption scheme. A plurality of oracle nodes are configured to authenticate computation requests and assign the computation requests to compute enclaves. The system also comprises a plurality of compute enclaves, each compute enclave comprising a trusted execution environment configured to execute computations on encrypted data. A plurality of decryption nodes are configured to generate encrypted decryption key shares for assigned compute enclaves based on encrypted inputs in the computation requests, such that each compute enclave receives only decryption key shares necessary to decrypt encrypted inputs assigned to that compute enclave. The plurality of oracle nodes are configured to verify attestations from the compute enclaves and provide attested responses.

According to other aspects of the present disclosure, the confidential computing system may include one or more of the following features. The plurality of decryption nodes may be configured to perform proactive re-sharing of the master secret key shares at regular intervals to prevent accumulation of compromised shares over time. Each compute enclave may be configured to generate a fresh public-private key pair for each computation request to enable forward-secure encryption of the encrypted decryption key shares. The plurality of decryption nodes may be configured to encrypt the decryption key shares using the fresh public key of the assigned compute enclave. The plurality of oracle nodes may be configured to assign computation requests to compute enclaves based on a consensus mechanism requiring a threshold number of oracle nodes to agree on the assignment. The encrypted inputs may include associated data that binds each encrypted input to a specific application or decryption policy to prevent unauthorized decryption outside an intended context. The plurality of decryption nodes may be configured to verify the associated data before generating the encrypted decryption key shares to ensure compliance with the decryption policy.

According to another aspect of the present disclosure, a method for confidential computing is provided. The method comprises receiving a computation request comprising encrypted inputs and a computation algorithm; authenticating the computation request using a plurality of oracle nodes; assigning the computation request to at least one compute enclave comprising a trusted execution environment; generating, by a plurality of decryption nodes holding shares of a master secret key, encrypted decryption key shares for the at least one assigned compute enclave, wherein the encrypted decryption key shares enable decryption of only the encrypted inputs assigned to the at least one compute enclave; executing the computation algorithm on decrypted inputs within the trusted execution environment of the at least one compute enclave; and generating an attested response from the at least one compute enclave.

According to other aspects of the present disclosure, the method may include one or more of the following features. The method may further comprise a step of performing proactive re-sharing of the master secret key shares among the plurality of decryption nodes at regular intervals. The method may further comprise a step of generating a fresh public-private key pair at the at least one compute enclave for the computation request to enable forward-secure encryption. Generating the encrypted decryption key shares may comprise encrypting the decryption key shares using the fresh public key of the at least one assigned compute enclave. Authenticating the computation request may comprise reaching consensus among a threshold number of the plurality of oracle nodes before assigning the computation request. The encrypted inputs may include associated data that binds each encrypted input to a specific application or decryption policy, and the method may further comprise a step of verifying the associated data before generating the encrypted decryption key shares. Verifying the associated data may comprise ensuring compliance with the decryption policy to prevent unauthorized decryption outside an intended context.

According to another aspect of the present disclosure, a method for managing private token transactions is provided. The method comprises maintaining an encrypted balance table within a private token contract, the encrypted balance table storing encrypted account balances for a plurality of addresses across multiple token types; receiving deposit operations from a plurality of native token contracts, wherein each deposit operation transfers tokens to the private token contract; updating the encrypted balance table to reflect increased encrypted account balances for recipient addresses specified in the deposit operations; receiving transfer operations that specify source addresses, destination addresses, token types, and transfer amounts; processing the transfer operations by decreasing encrypted account balances for the source addresses and increasing encrypted account balances for the destination addresses in the encrypted balance table while maintaining encryption of the balance information; and generating encrypted responses to balance inquiry operations without revealing actual balance amounts to unauthorized parties.

The foregoing general description of the illustrative embodiments and the following detailed description thereof are merely exemplary aspects of the teachings of this disclosure and are not restrictive.

### BRIEF DESCRIPTION OF FIG.S

Non-limiting and non-exhaustive examples are described with reference to the following FIG.s.

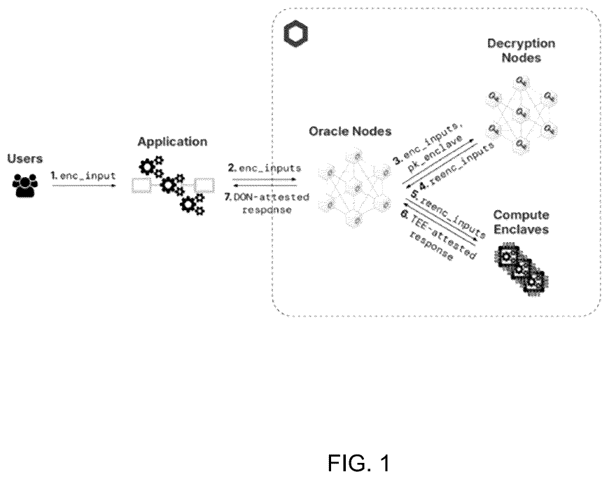

FIG. 1 illustrates a confidential computing system architecture according to aspects of the present disclosure.

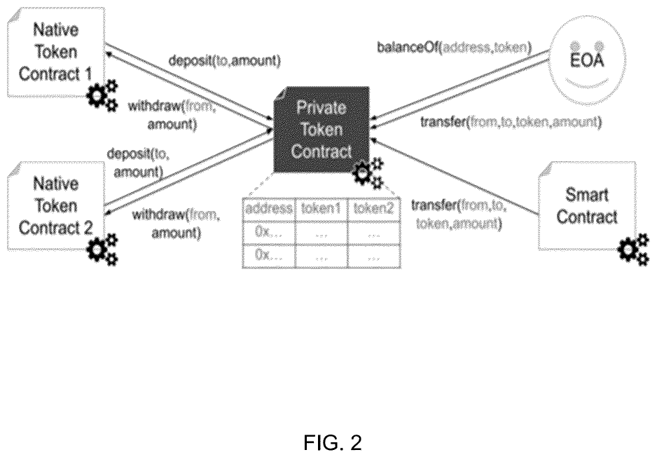

FIG. 2 illustrates a private token contract system architecture, according to aspects of the present disclosure.

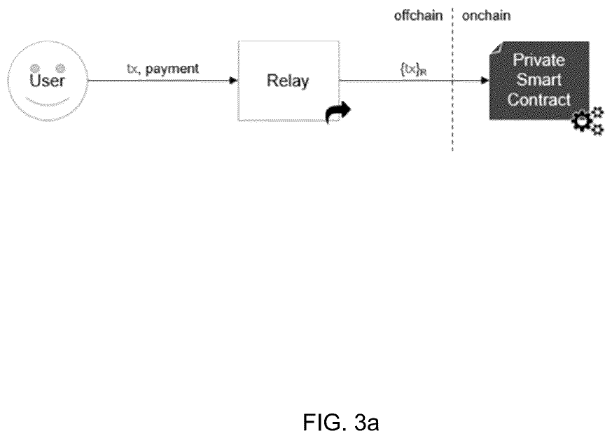

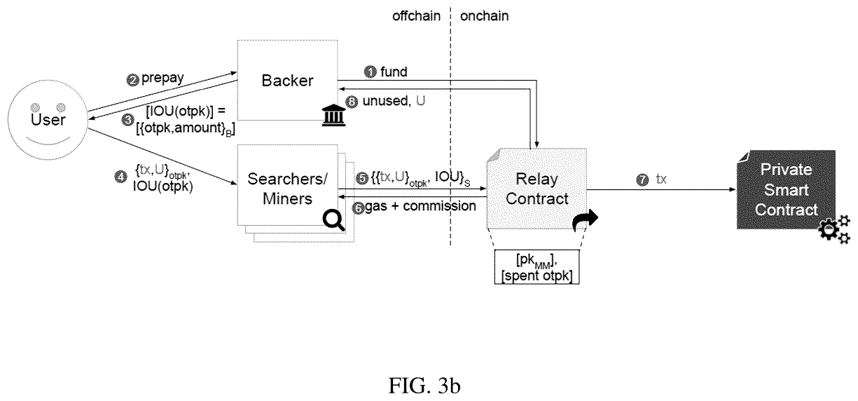

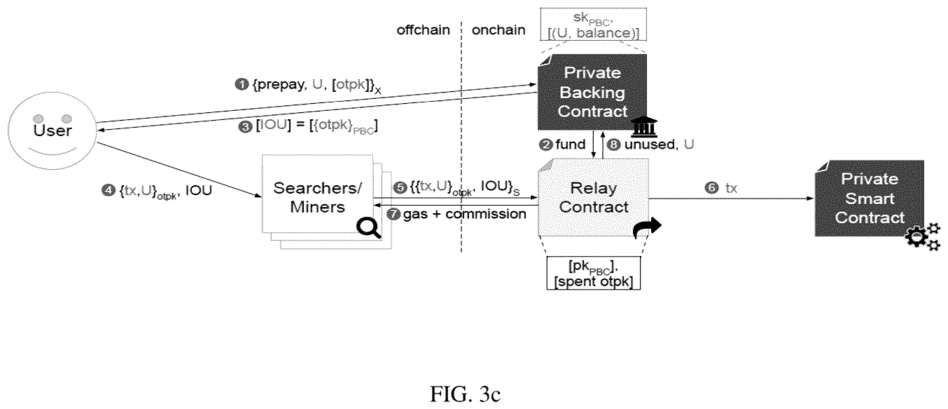

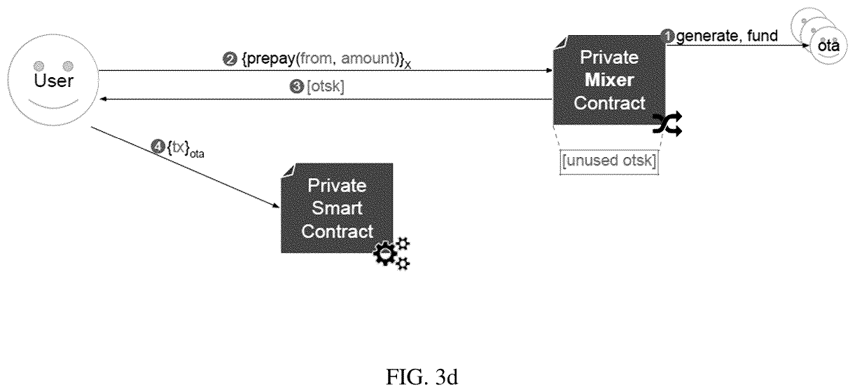

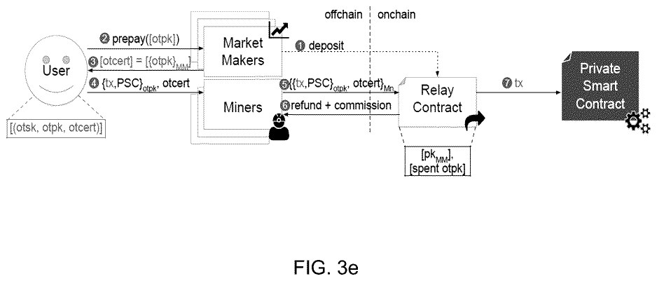

FIG. 3a illustrates a system architecture for anonymous gas payment mechanisms, according to aspects of the present disclosure.

FIG. 3b illustrates a system architecture for anonymous gas payment mechanisms, according to aspects of the present disclosure.

FIG. 3c illustrates a system architecture for anonymous gas payment mechanisms, according to aspects of the present disclosure.

FIG. 3d illustrates a system architecture for anonymous gas payment mechanisms, according to aspects of the present disclosure.

FIG. 3e illustrates a system architecture for anonymous gas payment mechanisms, according to aspects of the present disclosure.

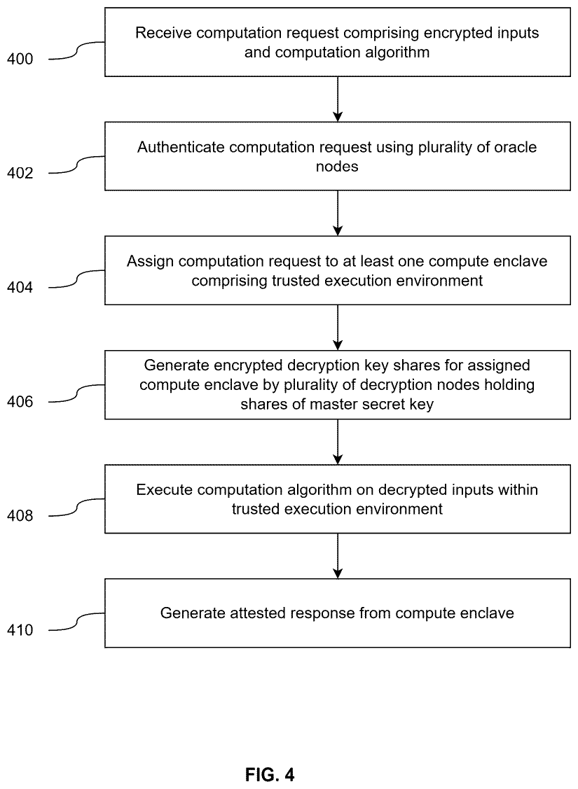

FIG. 4 is a flow chart of a method, according to aspects of the present disclosure.

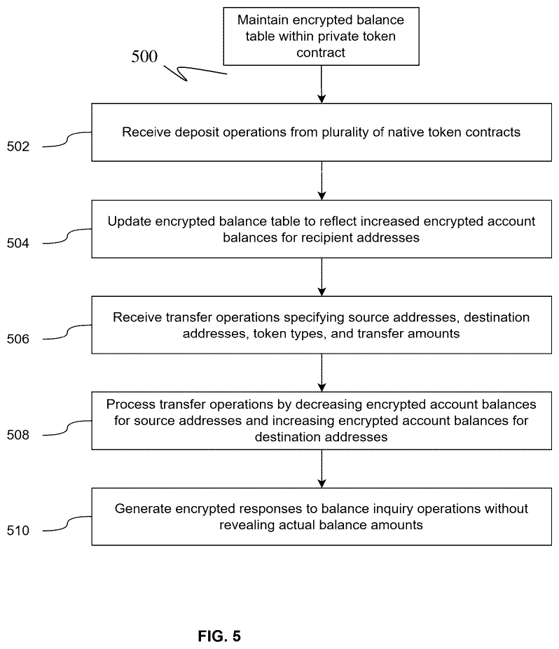

FIG. 5 is a flow chart of a method, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The integration of trusted execution environments with blockchain systems presents opportunities to combine the benefits of decentralized consensus with confidential computation capabilities. However, existing approaches often rely on centralized trust models or fail to adequately address the risks associated with compromised execution environments. Disclosed implementations address these issues and provide confidential computing systems and methods that can provide strong privacy guarantees while maintaining the decentralized nature of blockchain networks, and that can limit the impact of potential security breaches through robust architectural design and access control mechanisms.

FIG. 1 illustrates a confidential computing system 100 in accordance with disclosed implementations. Confidential computing system 100 can process sensitive data while maintaining privacy throughout computational workflows. The confidential computing system 100 may include encrypted sources 3 that provide various encrypted inputs to the system for secure processing. In some cases, the encrypted sources 3 may generate an encrypted input 1, encrypted inputs 2, encrypted inputs 4, and encrypted inputs 5, which represent data that has been encrypted to preserve confidentiality during computation operations.

The confidential computing system 100 may comprise a plurality of decryption nodes configured to collectively hold shares of a master secret key for a threshold encryption scheme. In some cases, the plurality of decryption nodes may be distributed across multiple computing environments to prevent any single node from possessing complete access to the master secret key. The threshold encryption scheme may enable decryption operations only when a predetermined number of decryption nodes collaborate, thereby providing distributed security for the encrypted inputs 1, 2, 4, and 5.

As further shown in FIG. 1, the confidential computing system 100 may include a plurality of oracle nodes configured to authenticate computation requests and assign the computation requests to compute enclaves. The plurality of oracle nodes may verify the authenticity and authorization of incoming computation requests before processing. In some cases, the plurality of oracle nodes may implement consensus mechanisms to ensure agreement among multiple nodes regarding request validation and enclave assignment decisions.

The confidential computing system 100 may further comprise a plurality of compute enclaves, where each compute enclave may include a trusted execution environment configured to execute computations on encrypted data. The trusted execution environments may provide hardware-based security guarantees for processing the encrypted inputs 1, 2, 4, and 5 while maintaining data confidentiality. In some cases, each compute enclave may be isolated from other system components and external access during computation operations.

With continued reference to FIG. 1, the plurality of decryption nodes may be configured to generate encrypted decryption key shares for assigned compute enclaves based on encrypted inputs in the computation requests. The encrypted decryption key shares may enable each compute enclave to decrypt only the specific encrypted inputs assigned to that particular enclave. This approach may implement a need-to-know principle where each compute enclave receives only decryption key shares necessary to decrypt encrypted inputs assigned to that compute enclave, thereby limiting potential exposure in case of compromise.

The plurality of oracle nodes may be configured to verify attestations from the compute enclaves and provide attested responses. As shown in FIG. 1, the confidential computing system 100 may generate an attested response 6 and an attested response 7 following completion of computational operations. The attested responses 6 and 7 may provide cryptographic proof that computations were performed correctly within the trusted execution environments of the compute enclaves.

In some cases, the confidential computing system 100 may be integrated within a runtime environment, such as the Chainlink Runtime Environment (CRE), as composable capabilities. The integration may include a Workflow distributed oracle network (DON) capability that coordinates computation requests, a Confidential Data capability that manages threshold decryption operations, and a confidential compute capability that provides access to the plurality of compute enclaves. These capabilities may be orchestrated through CRE workflows to enable seamless composition of confidential computing operations with other decentralized services.

The plurality of decryption nodes may be configured to collectively hold shares of a master secret key for a threshold encryption scheme, where the master secret key may be distributed among the decryption nodes such that no single node possesses complete access to the master secret key. In some cases, the threshold encryption scheme may require a predetermined minimum number of decryption nodes to collaborate in order to perform decryption operations, thereby providing distributed security for the confidential computing system 100.

The plurality of decryption nodes may be configured to perform proactive re-sharing of the master secret key shares at regular intervals to prevent accumulation of compromised shares over time. In some cases, the proactive re-sharing mechanism may refresh the master secret key shares among the decryption nodes without changing the underlying master secret key itself. The proactive re-sharing may be implemented through distributed key generation protocols that enable the decryption nodes to collectively generate new shares of the same master secret key while invalidating previous shares.

The proactive re-sharing protocols may be executed at predetermined epoch intervals, where each epoch may represent a time period during which the current set of master secret key shares remains valid. In some cases, the epoch management may involve coordinated transitions between epochs, where the plurality of decryption nodes may participate in re-sharing ceremonies to generate fresh shares for the subsequent epoch. The epoch transitions may be triggered automatically based on time intervals or manually based on security considerations.

During the proactive re-sharing process, the plurality of decryption nodes may engage in secure multi-party computation protocols to generate new polynomial shares of the master secret key. In some cases, each decryption node may contribute randomness to the re-sharing protocol while maintaining the mathematical relationship that enables threshold reconstruction of the master secret key. The re-sharing protocols may utilize verifiable secret sharing techniques to ensure that the newly generated shares are valid and consistent across all participating decryption nodes.

The encrypted inputs may be structured using hierarchical identity-based encryption where identities may be defined as vectors of strings, allowing ciphertexts encrypted to an identity vector to be decrypted by keys derived for any ancestor identity. The step of generating encrypted decryption key shares may use pairing-based cryptography with multiplicative groups and bilinear maps to enable efficient verification and aggregation of encrypted shares. In some cases, the pairing-based cryptography may utilize elliptic curve groups where the bilinear maps may provide mathematical properties that enable verification of encrypted key shares without revealing the underlying key material. The multiplicative groups may support efficient computation of threshold operations while maintaining the security properties of the encryption scheme.

The encrypted decryption key shares may be generated by applying each decryption node's share of the master secret key to derive partial decryption keys for specific encrypted inputs. In some cases, the partial decryption keys may be encrypted using the public keys of assigned compute enclaves to ensure that only the intended compute enclaves may access the decryption keys. The aggregation of encrypted shares may be performed within the trusted execution environments of the compute enclaves using the bilinear map properties to reconstruct the complete decryption keys for the assigned encrypted inputs.

Each compute enclave may be configured to generate a fresh public-private key pair for each computation request to enable forward-secure encryption of the encrypted decryption key shares. In some cases, the fresh key pair generation may occur at the initiation of each computation request, where the compute enclave may create a new asymmetric cryptographic key pair that remains valid only for the duration of that specific computation. The forward-secure encryption approach may ensure that compromise of a compute enclave at any given time may not enable decryption of encrypted inputs from previous or subsequent computation requests.

The fresh public-private key pair generation may utilize elliptic curve cryptography or RSA-based algorithms to create cryptographically secure key pairs within the trusted execution environment of each compute enclave. In some cases, the key generation process may incorporate hardware-based random number generators available within the trusted execution environment to ensure cryptographic randomness for the key material. The private key component of the fresh key pair may remain isolated within the trusted execution environment and may be automatically destroyed upon completion of the computation request.

The plurality of decryption nodes may be configured to encrypt the decryption key shares using the fresh public key of the assigned compute enclave. In some cases, the encryption process may involve each decryption node applying its share of the master secret key to generate a partial decryption key for the specific encrypted inputs, then encrypting the partial decryption key using the fresh public key provided by the assigned compute enclave. The encrypted decryption key shares may be transmitted to the compute enclave in a format that enables decryption only by the corresponding fresh private key.

The key lifecycle management may involve coordinated communication between the plurality of oracle nodes, the plurality of decryption nodes, and the assigned compute enclaves. In some cases, the compute enclave may publish the fresh public key to the plurality of oracle nodes as part of the computation request assignment process. The plurality of oracle nodes may then distribute the fresh public key to the plurality of decryption nodes along with the computation request details, enabling the decryption nodes to encrypt their respective key shares using the appropriate fresh public key.

The encrypted inputs may be aggregated using verifiably encrypted threshold public-key encryption schemes that enable untrusted hosts to verify and aggregate encrypted decryption shares without learning anything about the encrypted share contents. In some cases, the verifiably encrypted threshold schemes may provide cryptographic proofs that allow verification of the correctness of encrypted shares without revealing the underlying key material. The aggregation process may combine multiple encrypted decryption key shares into a compact representation that may be efficiently processed by the assigned compute enclave.

The verification process for encrypted decryption shares may utilize zero-knowledge proof techniques or pairing-based verification algorithms that enable confirmation of share validity without exposing sensitive cryptographic material. In some cases, each encrypted decryption key share may include accompanying proof data that demonstrates the share was correctly generated according to the threshold encryption protocol. The untrusted hosts may perform the verification and aggregation operations without gaining access to the actual decryption key material or the encrypted share contents.

The encrypted inputs may include dual threshold identity-based encryption that allows keys to be derived for particular identities as well as for particular ciphertexts, reducing bandwidth requirements for well-coordinated requests. In some cases, the dual threshold approach may enable derivation of decryption keys based on both identity-based criteria and ciphertext-specific parameters, providing flexible access control mechanisms. The identity-based component may allow decryption keys to be generated for specific applications, users, or organizational entities, while the ciphertext-specific component may enable fine-grained control over individual encrypted inputs.

The bandwidth reduction achieved through dual threshold identity-based encryption may result from the ability to derive multiple decryption keys from a single identity-based key derivation operation. In some cases, well-coordinated requests that involve multiple encrypted inputs with related identity structures may benefit from shared key derivation processes that reduce the total number of encrypted decryption key shares that need to be transmitted to compute enclaves. The dual threshold mechanism may enable efficient processing of batch computation requests where multiple encrypted inputs share common identity attributes or access control requirements.

The plurality of oracle nodes may be configured to implement consensus mechanisms for authenticating computation requests and coordinating assignment decisions across the distributed network. In some cases, the consensus mechanisms may require a threshold number of oracle nodes to reach agreement before computation requests may be assigned to compute enclaves. The threshold requirement may ensure that no single oracle node may unilaterally control the assignment process, thereby providing distributed decision-making for the confidential computing system.

The consensus mechanism may utilize Byzantine fault-tolerant protocols that enable the plurality of oracle nodes to reach agreement even when some oracle nodes may be compromised or unavailable. In some cases, the Byzantine fault-tolerant protocols may require a supermajority of oracle nodes to agree on computation request assignments, where the supermajority threshold may be configured to tolerate a predetermined number of faulty or malicious oracle nodes. The consensus protocols may implement voting mechanisms where each oracle node may cast votes regarding the validity and assignment of computation requests.

The authentication process for computation requests may involve multiple verification steps performed by the plurality of oracle nodes. In some cases, the oracle nodes may verify cryptographic signatures associated with computation requests to confirm the authenticity of the requesting applications. The authentication process may also include verification of request formatting, validation of encrypted input structures, and confirmation that the computation requests conform to expected protocol specifications.

The authentication of computation requests may include compliance checking where oracle nodes verify that requests comply with regulatory requirements and application-specific policies before assignment. In some cases, the compliance checking may involve evaluation of request metadata, assessment of data usage policies associated with encrypted inputs, and verification that the requesting applications have appropriate authorization to access the specified encrypted data. The oracle nodes may maintain policy databases or access external compliance services to perform the regulatory verification processes.

The assignment of computation requests to compute enclaves may be performed through distributed algorithms that consider factors such as enclave availability, computational capacity, and security requirements. In some cases, the plurality of oracle nodes may implement load balancing mechanisms that distribute computation requests across available compute enclaves to optimize resource utilization. The assignment algorithms may also consider geographic distribution, hardware diversity, and trust relationships when selecting appropriate compute enclaves for specific computation requests.

The consensus mechanism for enclave assignment may require the threshold number of oracle nodes to agree on both the selection of specific compute enclaves and the timing of request assignment. In some cases, the consensus process may involve multiple rounds of communication between oracle nodes, where each round may refine the assignment decision based on feedback from participating nodes. The consensus mechanism may implement timeout mechanisms to ensure that assignment decisions are reached within acceptable time bounds.

The plurality of oracle nodes may be configured to verify attestations from the compute enclaves before and after completion of computational operations. In some cases, the attestation verification process may involve cryptographic validation of attestation signatures, confirmation of enclave identity certificates, and verification that the attestations correspond to the originally assigned computation requests. The oracle nodes may maintain databases of trusted enclave identities and cryptographic keys to support the attestation verification processes.

The generation of attested responses may require consensus among the plurality of oracle nodes regarding the validity and correctness of computation results. In some cases, the oracle nodes may compare attestations from multiple compute enclaves when computation requests are assigned to multiple enclaves for redundancy. The consensus mechanism for attested response generation may implement majority voting or weighted voting schemes where oracle nodes may collectively determine the validity of computation results.

The threshold requirements for various operations performed by the plurality of oracle nodes may be configurable based on security requirements and operational considerations. In some cases, different types of computation requests may require different threshold levels, where more sensitive operations may require higher consensus thresholds among the oracle nodes. The threshold configuration may be managed through governance mechanisms that enable adjustment of consensus requirements based on evolving security needs and network conditions.

The plurality of oracle nodes may implement multi-valued consensus protocols that enable agreement on complex assignment decisions involving multiple parameters. In some cases, the multi-valued consensus may allow oracle nodes to reach agreement on index-value pairs that specify both the identity of assigned compute enclaves and associated operational parameters. The consensus protocols may provide consistency guarantees where all honest oracle nodes eventually output the same assignment decisions for each computation request.

The communication protocols between oracle nodes may utilize authenticated channels and cryptographic message integrity mechanisms to prevent tampering with consensus messages. In some cases, the oracle nodes may exchange signed messages during the consensus process, where each message may include cryptographic proofs of the sender's identity and the integrity of the message content. The communication protocols may also implement replay protection and ordering mechanisms to ensure that consensus messages are processed in the correct sequence.

The encrypted inputs may include associated data that binds each encrypted input to a specific application or decryption policy to prevent unauthorized decryption outside an intended context. In some cases, the associated data may comprise encryption labels that specify the intended usage parameters and access control requirements for each encrypted input. The associated data may be cryptographically bound to the encrypted content during the encryption process, creating an inseparable relationship between the encrypted data and the usage policy information.

The associated data may include application identifiers that specify which applications are authorized to request decryption of particular encrypted inputs. In some cases, the application identifiers may comprise blockchain addresses, smart contract addresses, or application-specific cryptographic identifiers that uniquely identify authorized requesting entities. The application identifiers may be structured as hierarchical identifiers that enable inheritance of access rights across related applications or organizational boundaries.

The decryption policy structures within the associated data may define temporal restrictions, geographic limitations, or computational constraints that govern when and how encrypted inputs may be decrypted. In some cases, the decryption policies may specify time windows during which decryption operations are permitted, geographic regions where computation may occur, or specific types of computational operations that are authorized for the encrypted data. The policy structures may be encoded using standardized policy languages or custom policy formats that enable machine-readable interpretation by the plurality of decryption nodes.

The encryption labels may include smart contract addresses that bind encrypted inputs to specific decentralized applications deployed on blockchain networks. In some cases, the smart contract addresses may serve as immutable identifiers that prevent encrypted inputs from being processed by unauthorized smart contracts or applications. The binding mechanism may utilize cryptographic hash functions or digital signature schemes that create tamper-evident associations between encrypted inputs and their intended smart contract destinations.

The associated data may incorporate blockchain addresses that identify specific accounts or entities authorized to initiate computation requests involving particular encrypted inputs. In some cases, the blockchain addresses may represent user accounts, organizational accounts, or service accounts that have been granted permission to access specific encrypted data sets. The address-based binding may enable fine-grained access control where different blockchain addresses may have different levels of access to encrypted inputs based on their associated permissions.

The plurality of decryption nodes may be configured to verify the associated data before generating the encrypted decryption key shares to ensure compliance with the decryption policy. In some cases, the verification process may involve cryptographic validation of the associated data integrity, confirmation that the requesting application matches the authorized application identifiers, and assessment of whether the computation request complies with the specified decryption policies. The verification may be performed independently by each decryption node before contributing to the threshold decryption process.

The verification of associated data may include policy evaluation mechanisms where the plurality of decryption nodes assess whether current conditions satisfy the requirements specified in the decryption policies. In some cases, the policy evaluation may involve checking temporal constraints against current timestamps, validating geographic restrictions against the location of compute enclaves, or confirming that the requested computational operations fall within the permitted scope defined by the decryption policies. The policy evaluation may utilize external data sources or oracle services to obtain current condition information.

The compliance checking process may involve cross-referencing the application identifiers in the associated data with authorized application registries maintained by the plurality of decryption nodes. In some cases, the decryption nodes may maintain distributed databases of authorized applications, smart contracts, and blockchain addresses that are permitted to access encrypted inputs with specific policy requirements. The cross-referencing process may include verification of application certificates, validation of smart contract deployment authenticity, and confirmation of blockchain address ownership.

The associated data verification may implement cryptographic proof mechanisms that enable the plurality of decryption nodes to verify policy compliance without revealing sensitive information about the encrypted inputs or the requesting applications. In some cases, the proof mechanisms may utilize zero-knowledge proof techniques that demonstrate compliance with decryption policies while preserving the confidentiality of the underlying data and application details. The cryptographic proofs may be generated by requesting applications and verified by the decryption nodes as part of the policy compliance assessment.

The decryption policy enforcement may include audit trail generation where the plurality of decryption nodes record policy verification decisions and compliance assessments for subsequent review. In some cases, the audit trails may include timestamps of verification activities, identifiers of participating decryption nodes, and summaries of policy evaluation results without revealing sensitive details about the encrypted inputs or computation requests. The audit information may be stored in distributed ledgers or secure logging systems to provide accountability and regulatory compliance capabilities.

The trusted execution environment within each compute enclave may be configured to provide hardware-based security guarantees for processing encrypted data while maintaining isolation from external access during computational operations. In some cases, the trusted execution environment may utilize secure enclave technologies such as Intel SGX, AMD SEV, or ARM TrustZone that create protected memory regions where computations may be performed without exposure to the host operating system or other software components. The trusted execution environment may implement memory encryption, code integrity verification, and attestation mechanisms that enable verification of the execution environment's authenticity and security properties.

The compute enclaves may be configured to operate under different security profiles depending on application requirements and trust assumptions. In some cases, the security profiles may provide varying levels of confidentiality protection, integrity assurance, and performance characteristics to accommodate different use case requirements. The selection of security profiles may be determined by factors such as the sensitivity of encrypted inputs, regulatory compliance requirements, and acceptable performance trade-offs for specific applications.

A single execution security profile may assign each computation request to one compute enclave that executes the computation algorithm within the trusted execution environment. In some cases, the single execution profile may provide optimal performance characteristics since computational overhead is minimized through execution on a single enclave without coordination requirements. The confidentiality of encrypted inputs may be protected through the hardware security guarantees of the trusted execution environment, while integrity may be assured through cryptographic attestation mechanisms that verify correct execution within the secure enclave.

The single execution profile may implement strict need-to-know principles where the assigned compute enclave receives only the decryption key shares necessary to decrypt the specific encrypted inputs assigned to that computation request. In some cases, the isolation provided by the single execution approach may limit the potential impact of enclave compromise to only those computation requests assigned to the compromised enclave after the compromise occurs. The forward-secure encryption mechanisms may ensure that compromise of a compute enclave does not enable access to encrypted inputs from previous or subsequent computation requests.

A replicated execution security profile may assign computation requests to multiple compute enclaves that execute the same computation algorithm in parallel across different trusted execution environments. In some cases, the replicated execution approach may enhance integrity assurance by enabling comparison of results across multiple independent execution environments. The plurality of oracle nodes may verify that all assigned compute enclaves produce identical results before generating attested responses, thereby detecting potential execution errors or malicious behavior within individual enclaves.

The replicated execution profile may require deterministic computation algorithms to ensure that multiple compute enclaves produce identical results when processing the same encrypted inputs. In some cases, deterministic randomness may be generated using threshold verifiable random functions implemented by the plurality of decryption nodes to provide consistent random values across all participating compute enclaves. The threshold verifiable random functions may generate cryptographically secure random values that are deterministic for each computation request while preventing grinding attacks where adversaries attempt to manipulate random outcomes.

The deterministic randomness generation may utilize the same cryptographic infrastructure used for threshold decryption, where the plurality of decryption nodes may apply their master secret key shares to generate verifiable random function outputs for specific computation requests. In some cases, the random function outputs may be encrypted and distributed to assigned compute enclaves using the same mechanisms employed for encrypted decryption key shares. The deterministic randomness may ensure that randomized algorithms produce reproducible results across multiple enclaves while maintaining cryptographic security properties.

The replicated execution profile may involve trade-offs between enhanced integrity assurance and reduced confidentiality protection, since compromise of any single assigned compute enclave may expose the encrypted inputs to adversaries. In some cases, the number of compute enclaves assigned to each computation request may be configurable based on the desired balance between integrity and confidentiality requirements. Applications requiring higher integrity assurance may utilize larger numbers of replicated enclaves, while applications prioritizing confidentiality protection may limit the number of assigned enclaves.

A zero-knowledge attestation security profile may enhance the single execution approach by requiring compute enclaves to generate cryptographic proofs of correct execution alongside computation results. In some cases, the zero-knowledge proofs may provide mathematical guarantees of execution integrity rather than relying solely on hardware attestation mechanisms. The zero-knowledge proofs may demonstrate that the computation algorithm was executed correctly on the decrypted inputs without revealing information about the inputs themselves or intermediate computation states.

The zero-knowledge proof generation may utilize advanced cryptographic techniques such as zk-SNARKs, zk-STARKs, or other zero-knowledge proof systems that enable efficient verification of computation correctness. In some cases, the proof generation process may require additional computational resources within the trusted execution environment, resulting in performance trade-offs compared to basic execution profiles. The zero-knowledge proofs may be verified by the plurality of oracle nodes before generating attested responses, providing cryptographic assurance of execution integrity.

The zero-knowledge attestation profile may enable applications to achieve high levels of integrity assurance while maintaining confidentiality protection through single enclave execution. In some cases, the mathematical guarantees provided by zero-knowledge proofs may be preferred over hardware-based attestation for applications requiring formal verification of computation correctness. The zero-knowledge proofs may also enable public verification of computation integrity by external parties without requiring access to the encrypted inputs or computation results.

A secure multi-party computation execution profile may distribute computation requests across multiple compute enclaves that jointly compute over secret shares of the encrypted inputs without any single enclave learning the complete input values. In some cases, the secure multi-party computation approach may utilize threshold secret sharing schemes where the encrypted inputs are divided into cryptographic shares that are distributed among participating compute enclaves. The computation algorithm may be executed collaboratively across the enclaves using secure multi-party computation protocols that preserve the confidentiality of individual input shares.

The secure multi-party computation profile may require specialized threshold encryption schemes that enable distribution of encrypted inputs into secret shares suitable for multi-party computation protocols. In some cases, the plurality of decryption nodes may generate encrypted shares of the decryption keys that correspond to the secret sharing scheme used for distributing the encrypted inputs. The compute enclaves may participate in secure multi-party computation protocols that enable joint computation over the secret shares while maintaining the confidentiality of individual shares throughout the computation process.

The secure multi-party computation execution may provide enhanced confidentiality protection since no single compute enclave gains access to complete encrypted input values during the computation process. In some cases, the distributed computation approach may also provide integrity assurance through the cryptographic properties of the multi-party computation protocols. The secure multi-party computation profile may involve significant performance overhead due to the communication and cryptographic operations required for collaborative computation across multiple enclaves.

A fully homomorphic encryption execution profile may enable compute enclaves to perform operations on encrypted inputs using homomorphic properties without decrypting the input values during computation. In some cases, the fully homomorphic encryption approach may allow computation algorithms to be executed directly on encrypted data, where the results remain encrypted throughout the computation process. The compute enclaves may jointly decrypt only the final computation outputs using threshold decryption mechanisms provided by the plurality of decryption nodes.

The fully homomorphic encryption profile may utilize advanced cryptographic schemes that support arbitrary computations on encrypted data while preserving the encryption properties throughout the computation process. In some cases, the homomorphic encryption schemes may enable addition, multiplication, and other mathematical operations to be performed on encrypted values without revealing the underlying plaintext data. The computation results may remain encrypted until the final decryption step, providing strong confidentiality protection throughout the entire computation workflow.

The fully homomorphic encryption execution may provide maximal confidentiality protection since the encrypted inputs remain encrypted throughout the computation process within the compute enclaves. In some cases, the fully homomorphic encryption approach may also provide integrity assurance through the mathematical properties of the homomorphic encryption schemes. The fully homomorphic encryption profile may involve substantial performance overhead due to the computational complexity of homomorphic operations, making this approach suitable for applications where confidentiality requirements outweigh performance considerations.

The selection of security profiles may be determined by application-specific requirements regarding confidentiality, integrity, and performance characteristics. In some cases, applications processing highly sensitive data may prioritize confidentiality protection through secure multi-party computation or fully homomorphic encryption profiles, while applications requiring high-performance computation may utilize single execution or replicated execution profiles. The configurable security profiles may enable the confidential computing system to accommodate diverse application requirements within a unified infrastructure.

The integrity assurance mechanisms may differ across security profiles, ranging from hardware-based attestation in single execution profiles to cryptographic proofs in zero-knowledge attestation profiles and protocol-based assurance in multi-party computation profiles. In some cases, applications may select security profiles based on the level of integrity assurance required for specific use cases and the acceptable trust assumptions regarding hardware security, cryptographic protocols, and distributed computation mechanisms. The configurable security profiles may enable applications to optimize the balance between security guarantees and operational efficiency based on their specific requirements.

FIG. 2 illustrates an example use case of the system of FIG. 1, a private token contract. Referring to FIG. 2, a private token contract system 200 may be configured to manage confidential digital token (such as cryptocurrency) transactions while maintaining privacy of balance information and transaction details. The private token contract system may include a Private token Contract, for example, a smart contract, that maintains an encrypted balance table containing addresses and token balances stored as encrypted values. In some cases, the encrypted balance table may include columns for address identifiers, token1 balances, and token2 balances, where each entry may be represented as encrypted values to preserve confidentiality of account information, as shown in FIG. 2.

The private token contract system 200 may comprise a plurality of Native Token Contracts that interact with the Private token Contract through deposit and withdraw operations. In some cases, the plurality of Native Token Contracts may include Native Token Contract 1 and Native Token Contract 2, each representing different token types that may be managed within the private token contract system. The Native Token Contracts may implement standard token interfaces while providing integration capabilities with the confidential token management infrastructure.

As further shown in FIG. 2, the private token contract system may include an EOA (Externally Owned Account) and a token operation smart contract positioned on the right side of the system architecture that interact with the Private token Contract through balanceOf queries and transfer operations. The EOA may represent individual user accounts that may perform balance inquiries and initiate token transfers within the private token contract system. In some cases, the token operation smart contract may represent automated applications or decentralized protocols that may interact with the private token infrastructure to perform programmatic token operations.

The Private token Contract may be configured to process deposit operations by receiving tokens from the plurality of Native Token Contracts and updating the encrypted balance table to reflect increased encrypted account balances for specified recipient addresses. In some cases, the deposit operations may involve transfer of tokens from the Native Token Contracts to the Private token Contract, where the deposit amounts may be added to the encrypted balance entries corresponding to the recipient addresses. The deposit process may utilize the confidential computing infrastructure to perform encrypted arithmetic operations that increase the encrypted balance values without revealing the actual balance amounts or transaction details.

The deposit operations may include parameters specifying the recipient address and the amount of tokens to be deposited into the private token contract system. In some cases, the recipient address may be encrypted during the deposit process to maintain privacy of the account identifiers within the encrypted balance table. The Private token Contract may process the deposit by looking up the encrypted balance entry for the recipient address and performing encrypted addition operations to increase the balance by the deposited amount while maintaining the encryption of the balance information.

The Private token Contract may be configured to process withdraw operations by decreasing encrypted account balances in the encrypted balance table and transferring corresponding token amounts from the Private token Contract to caller addresses in the plurality of Native Token Contracts. In some cases, the withdraw operations may involve verification of account ownership and sufficient balance availability before performing the encrypted balance updates and token transfers. The withdraw process may utilize authentication mechanisms to ensure that only authorized parties may withdraw tokens from specific encrypted account balances.

The withdraw operations may include parameters specifying the source address from which tokens are to be withdrawn and the amount of tokens to be transferred back to the Native Token Contracts. The Private token Contract may verify that the encrypted balance for the source address contains sufficient tokens to satisfy the withdrawal request before proceeding with the operation. The withdraw process may involve encrypted subtraction operations that decrease the encrypted balance values while transferring the corresponding token amounts from the Private token Contract back to the caller addresses in the appropriate Native Token Contracts.

The Private token Contract may be configured to process balance inquiry operations by providing encrypted balance information for specified addresses and token types without revealing actual balance amounts. The balance inquiry operations may be initiated by the EOA or Smart Contract through balanceOf queries that specify the account address and token type for which balance information is requested. In some cases, the balance inquiry operations may return encrypted balance values that may be decrypted only by authorized parties possessing appropriate decryption capabilities.

The balanceOf operations may include parameters specifying the owner address and token type for which balance information is being queried. In some cases, the Private token Contract may look up the encrypted balance entry corresponding to the specified address and token type within the encrypted balance table. The balance inquiry process may return encrypted balance information that preserves the confidentiality of the actual balance amounts while enabling authorized parties to access the balance data through appropriate decryption mechanisms.

The Private token Contract may implement transfer operations that enable movement of tokens between different addresses within the private token contract system while maintaining encryption of the balance information throughout the transfer process. In some cases, the transfer operations may specify source addresses, destination addresses, token types, and transfer amounts as parameters for the token movement. The transfer process may involve encrypted arithmetic operations that decrease the encrypted balance for the source address and increase the encrypted balance for the destination address while preserving the confidentiality of all balance information.

The transfer operations may utilize the confidential computing infrastructure of FIG. 1 to perform encrypted balance updates without revealing the actual balance amounts or transfer details to unauthorized parties. In some cases, the transfer process may include authentication mechanisms that verify the authorization of the requesting party to initiate transfers from the specified source address. The Private token Contract may process transfers by performing encrypted subtraction operations on the source address balance and encrypted addition operations on the destination address balance while maintaining the encryption properties throughout the transaction.

The encrypted balance table maintained by the Private token Contract may support multiple token types simultaneously, enabling users to hold and manage different types of tokens within the same private token contract system. In some cases, the encrypted balance table may include separate balance entries for each combination of address and token type, allowing for comprehensive token portfolio management within the confidential infrastructure. The multi-token support may enable complex token operations such as atomic swaps, portfolio rebalancing, and cross-token transfers while maintaining privacy of all balance and transaction information.

The Private token Contract may implement access control mechanisms that govern which parties may perform specific operations on encrypted account balances. In some cases, the access control may include authentication requirements for withdraw and transfer operations, while balance inquiry operations may require appropriate viewing permissions or decryption capabilities. The access control mechanisms may utilize cryptographic authentication methods such as digital signatures, encrypted authentication tokens, or threshold authentication schemes that enable secure verification of operation authorization without compromising the privacy of the encrypted balance information.

The balance inquiry operations may include encrypted viewing keys that enable authorized parties to decrypt balance information while maintaining confidentiality from unauthorized parties. In some cases, the encrypted viewing keys may serve as cryptographic credentials that grant specific decryption capabilities to designated parties without exposing the encrypted balance information to other system participants. The viewing keys may be generated and distributed through secure mechanisms that ensure only authorized parties receive the appropriate decryption capabilities for accessing specific encrypted balance data.

The encrypted viewing keys may be generated using a threshold encryption scheme that requires a minimum number of decryption nodes to collaborate in providing access to the encrypted balance information. In some cases, the threshold encryption scheme may distribute the viewing key generation process across multiple decryption nodes such that no single node may independently generate viewing keys for encrypted balance data. The collaborative key generation process may ensure that viewing key creation requires consensus among a predetermined threshold of decryption nodes, thereby providing distributed control over access to encrypted balance information.

The key derivation mechanisms for encrypted viewing keys may utilize hierarchical key derivation protocols where master viewing keys may be derived from the threshold encryption infrastructure and subsequently used to generate specific viewing keys for individual balance inquiries. In some cases, the hierarchical approach may enable efficient generation of viewing keys for related balance queries while maintaining cryptographic separation between different viewing contexts. The key derivation process may incorporate identity-based parameters that bind viewing keys to specific authorized parties and balance inquiry contexts.

The distribution mechanisms for encrypted viewing keys may involve secure communication protocols between the plurality of decryption nodes and the authorized parties requesting balance information. In some cases, the decryption nodes may encrypt the viewing keys using the public keys of authorized parties before transmitting the viewing key material through secure channels. The distribution process may include authentication mechanisms that verify the identity and authorization of parties requesting viewing keys before providing access to the encrypted balance decryption capabilities.

Further, the private token contract system may support anonymous gas payment mechanisms including centralized trusted relays, decentralized searchers with centralized backers, on-chain private backer contracts, and pre-funded one-time addresses to prevent transaction linkability through gas payments. In some cases, the anonymous gas payment mechanisms may address privacy concerns related to blockchain transaction fees that could otherwise enable correlation of private token transactions with specific user accounts. The gas payment anonymization may utilize various approaches depending on the desired balance between decentralization, privacy protection, and operational complexity.

The centralized trusted relay approach may involve a relay service that submits private token transactions on behalf of users while paying the associated gas fees from pooled accounts. In some cases, the relay service may receive encrypted transaction requests from users and submit the transactions to the blockchain using the relay's own accounts for gas payment. The relay approach may provide transaction unlinkability by preventing direct association between user accounts and the gas payment addresses, though the relay service may observe the correlation between users and their encrypted transactions.

The decentralized searchers with centralized backers approach may utilize a distributed network of searchers who compete to submit private token transactions while receiving gas payment support from centralized backing services. In some cases, the searchers may earn commissions for successfully submitting transactions while the centralized backers provide the necessary gas payment funding. The approach may combine decentralized transaction submission with centralized gas payment coordination to achieve transaction privacy while maintaining operational efficiency.

The on-chain private backer contracts may utilize the confidential computing infrastructure to manage gas payment pools while maintaining privacy of the payment relationships between users and gas funding sources. In some cases, the private backer contracts may accept encrypted deposits from users and subsequently provide encrypted gas payment authorizations that enable transaction submission without revealing the connection between specific users and their gas payments. The on-chain approach may enable fully decentralized gas payment anonymization through smart contract automation.

Temporary blockchain addresses can be generated and pre-funded with “gas” payment amounts and used for single transaction submissions before being discarded. In some cases, the one-time addresses may be generated in batches and distributed to users through secure channels, enabling users to submit private token transactions using fresh addresses that cannot be linked to their primary accounts. The one-time address approach may provide strong transaction unlinkability while requiring coordination mechanisms for address generation and distribution. The term “gas”, as used herein, relates to fees paid for compute resources on a decentralized network, such as an ethereum network.

The private token contract system may include audit interfaces that allow authorized auditors to inspect individual balances and transactions without granting blanket mass surveillance capabilities, with configurable rules for which auditors can inspect which data under which circumstances. In some cases, the audit interfaces may provide selective access to encrypted balance and transaction information based on predefined authorization criteria and regulatory compliance requirements. The audit mechanisms may enable regulatory oversight while preserving user privacy through targeted rather than comprehensive surveillance capabilities.

The audit interfaces may implement role-based access control where different categories of auditors receive different levels of access to encrypted balance and transaction data. In some cases, financial regulators may receive access to balance information for specific accounts under investigation, while tax authorities may receive access to transaction history data for compliance verification purposes. The role-based approach may enable fine-grained control over audit capabilities based on the specific regulatory authority and investigation context.

One potential security gap can result from the need to pay transasction fees, referred to as “gas” fees herein. Since the gas fee payment account is often public, anonymity can be compromised. Disclosed implementations include system architectures for anonymous gas payment to address privacy concerns related to blockchain transaction fees that could enable correlation of private token transactions with specific user accounts. The system may include multiple approaches for anonymizing gas payments while maintaining the confidentiality properties of the private token infrastructure. In some cases, the anonymous gas payment mechanisms may prevent transaction linkability by decoupling the relationship between user identities and the blockchain addresses used to pay transaction fees.

In the example shown in FIG. 3a, the system architecture may include a central trusted relay component that receives encrypted transaction requests (tx) and gas payments from users and submits the transactions to the blockchain network using pooled gas payment accounts. In some cases, the trusted relay may maintain a collection of funded blockchain addresses that are used to pay gas fees for multiple users, thereby preventing direct correlation between individual users and their transaction gas payments. The relay service may process encrypted transaction submissions without learning the content of the transactions while providing gas payment anonymization through address pooling. The central relay allows user to make offchain payments to the relay service and submit encrypted transaction under the identity of the relay and the relay pays gas fees without compromising the identity of the user.

In the example shown in FIG. 3b, payments are made through one or more decentralized searchers and a central backer. At step 1, a backer funds an onchain relay contract. At step 2, a user prepays gas fees to the backer. At step 3, the backer transmits a guarantee statement (IOU), a commission amount, and a one time public key (otpk) for the transaction. At step 4, the user submits the guarantee statement and the one time public key to one or more of the decentralized searchers. One of the searchers agrees to transmit the transaction to the blockchain in exchange for the commission amount and, at step 5, the searcher transmits the encrypted transaction, the guarantee statement, and the one time public key to the onchain relay contract. At step 6, the relay contract transmits the gas fee and the commission to the searcher. At step 7, the relay contract submits the transaction to a private smart contract on the blockchain. The user can also batch transactions by submitting multiple transactions with the corresponding one time public keys, which are used to identify each transaction and the payments.

The example shown in FIG. 3c is similar to the example of FIG. 3b. However, in the example of FIG. 3c, the backer is an onchain backing contract that leverages the secure systems disclosed herein, such as the system illustrated in FIG. 1. The user obtains the guarantees from backing contract signed with secret key by the backing contract. This arrangement does not require prediction of gas fees, and refunds can be handled directly between the relay contract and the backing contract.

In the example shown in FIG. 3d, pre-funded one-time addresses are used. An onchain private mixer contract creates and funds one-time addresses (ota), and hands a batch of secret keys to such one-time addresses (otsk) to users in exchange for payments. The users can then submit their encrypted transaction signed under the one-time address.

In the example shown in FIG. 3e, offchain market makers are essentially an extension of the searchers/miners scheme of FIG. 3b, where there can be a whole community of market makers (similar to backers). For additional privacy the market makers, this example uses blind signatures to sign the guarantees (otcerts).

The trusted relay mechanism may implement transaction batching capabilities where multiple encrypted transactions from different users are combined into batch submissions that further obscure the relationship between individual users and specific transactions. In some cases, the batching process may involve collecting encrypted transactions over predetermined time intervals and submitting them as coordinated batch operations that share gas payment costs across multiple users. The batch submission approach may enhance privacy protection while improving gas payment efficiency through cost sharing mechanisms.

As further shown in FIG. 3, the system may include decentralized searcher networks that compete to submit private token transactions while receiving gas payment support from centralized backing services. The decentralized searchers may operate as independent entities that monitor for pending encrypted transaction requests and compete to submit the transactions to the blockchain network. In some cases, the searcher competition may provide decentralized transaction submission while maintaining centralized coordination for gas payment funding and commission distribution.

The searcher network architecture may implement commission-based incentive mechanisms where searchers receive rewards for successfully submitting encrypted transactions to the blockchain network. In some cases, the commission structure may be funded by centralized backing services that provide gas payment resources in exchange for transaction submission services. The incentive mechanisms may encourage participation in the decentralized searcher network while ensuring reliable transaction submission capabilities for private token operations.

The centralized backer components within the searcher network may utilize threshold unlinkable divisible e-cash systems to provide anonymous payment capabilities for gas funding while maintaining accountability for searcher commission payments. In some cases, the e-cash mechanisms may enable searchers to receive gas payment authorizations without revealing their identities to the centralized backers, thereby preserving privacy within the gas payment coordination process. The divisible e-cash approach may support flexible payment amounts while providing cryptographic unlinkability between payment authorizations and specific searcher identities.

With continued reference to FIG. 3, the system may include on-chain private backer contracts that utilize the confidential computing infrastructure to manage gas payment pools while maintaining privacy of the payment relationships between users and gas funding sources. The on-chain private backer contracts may accept encrypted deposits from users and maintain encrypted account balances that may be used to authorize gas payments for subsequent private token transactions. In some cases, the on-chain approach may enable fully decentralized gas payment anonymization without relying on trusted third parties for gas payment coordination.

The on-chain private backer implementation may utilize the same encrypted balance management techniques employed by the private token contract system to maintain confidential gas payment account balances. In some cases, the private backer contracts may process encrypted deposit operations that increase user gas payment balances and encrypted withdrawal operations that authorize gas payments for specific transaction submissions. The encrypted balance management may ensure that gas payment relationships remain confidential while enabling automated gas payment authorization through smart contract mechanisms.

The private backer contracts may implement daisy-chaining mechanisms for anonymous gas payments where initial gas payment deposits enable subsequent deposits through a chain of anonymous transactions. In some cases, the daisy-chaining approach may allow users to bootstrap anonymous gas payment capabilities by making initial deposits from identifiable accounts and subsequently using the anonymous gas payment system to fund additional deposits without revealing the connection to their original accounts. The chaining mechanism may provide ongoing anonymous gas payment capabilities through self-reinforcing privacy protection.

The system may include off-chain market maker components that provide blind signature services for one-time gas payment authorizations, enabling users to obtain anonymous gas payment capabilities without revealing their identities to the market makers. In some cases, the blind signature mechanisms may utilize cryptographic protocols such as blind BLS signatures that enable market makers to authorize gas payments without learning the specific payment details or user identities. The market maker approach may provide decentralized anonymous gas payment services while maintaining operational efficiency through specialized service providers.

The market maker ecosystem may support multiple independent service providers that compete to offer anonymous gas payment services, thereby preventing single points of failure and enabling users to select market makers based on factors such as pricing, reliability, and trust preferences. In some cases, the competitive market maker environment may drive innovation in anonymous gas payment techniques while providing redundancy and choice for users requiring transaction privacy protection. The ecosystem approach may enable sustainable operation of anonymous gas payment services through market-based incentive mechanisms.

The blind signature protocols employed by market makers may implement divisible e-cash mechanisms that enable flexible gas payment amounts while maintaining unlinkability between payment authorizations and specific users. In some cases, the divisible e-cash approach may allow users to obtain gas payment authorizations for various transaction sizes without requiring separate authorization processes for each payment amount. The flexible payment capabilities may enhance the usability of anonymous gas payment services while preserving the cryptographic privacy properties of the blind signature mechanisms.

The integration between anonymous gas payment mechanisms and the private token contract system may involve coordination protocols that ensure gas payment anonymization does not compromise the confidentiality properties of the encrypted token operations. In some cases, the coordination protocols may synchronize gas payment timing with encrypted transaction submission to prevent correlation attacks that could link anonymous gas payments with specific private token operations. The integrated approach may provide comprehensive transaction privacy that encompasses both the token operation content and the associated gas payment mechanisms.

FIG. 4 illustrates a method for processing computation requests while maintaining data privacy and security throughout the computational workflow in accordance with disclosed implementations. The method may begin at step 400 where a computation request comprising encrypted inputs and a desired computation algorithm is received. The computation request may include multiple encrypted inputs that have been encrypted under the master public key of the threshold encryption scheme, along with a specification of the computation algorithm that should be executed on the decrypted input data.

The computation request received in step 400 may include encrypted inputs similar to the encrypted input 1, encrypted inputs 2, encrypted inputs 4, and encrypted inputs 5 described in relation to the confidential computing system architecture illustrated in FIG. 1. In some cases, the encrypted inputs may originate from various encrypted sources 3 (FIG. 1) that provide sensitive data for processing within the confidential computing infrastructure. The computation algorithm specification may define the operations to be performed on the decrypted inputs, including mathematical computations, data transformations, or logical operations that require access to the plaintext values of the encrypted inputs.

The method proceeds to step 402 where the computation request is authenticated using a plurality of oracle nodes (see FIG. 1). In some cases, the authentication process in step 402 may involve verification of the computation request's authenticity, validation of the requesting application's authorization, and confirmation that the request complies with applicable policies and security requirements. The plurality of oracle nodes may perform independent authentication checks before reaching consensus on the validity of the computation request.

The authentication protocols implemented in step 402 may include cryptographic signature verification where the plurality of oracle nodes validate digital signatures associated with the computation request to confirm the identity of the requesting application. In some cases, the signature verification process may involve checking signatures against registered public keys for authorized applications, smart contracts, or user accounts that are permitted to submit computation requests. The authentication protocols may also include verification of request formatting, validation of encrypted input structures, and confirmation that the computation requests conform to expected protocol specifications.

The consensus mechanisms employed during step 402 may require a threshold number of the plurality of oracle nodes to agree on the authentication decision before the computation request may proceed to the assignment phase. In some cases, the consensus process may implement Byzantine fault-tolerant protocols that enable the oracle nodes to reach agreement even when some nodes may be compromised or unavailable. The threshold requirement may ensure that no single oracle node may unilaterally approve or reject computation requests, thereby providing distributed decision-making for the authentication process.

The consensus mechanisms may utilize voting protocols where each oracle node casts votes regarding the validity and authorization of computation requests based on their independent authentication assessments. In some cases, the voting process may require a supermajority of oracle nodes to approve computation requests, where the supermajority threshold may be configured to tolerate a predetermined number of faulty or malicious oracle nodes. The consensus protocols may implement timeout mechanisms to ensure that authentication decisions are reached within acceptable time bounds.

Following successful authentication in step 402, the method continues to a step 404 where the computation request is assigned to at least one compute enclave comprising a trusted execution environment (see FIG. 1). In some cases, the assignment process in step 404 may involve selection of appropriate compute enclaves from the available pool based on factors such as enclave availability, computational capacity, security requirements, and load balancing considerations. The assignment decision may be made collectively by the plurality of oracle nodes through consensus mechanisms similar to those used for authentication.

The assignment algorithms implemented in step 404 may consider various factors when selecting compute enclaves for specific computation requests. In some cases, the selection process may evaluate the computational requirements of the requested algorithm, the security profile requirements specified in the computation request, and the current workload distribution across available compute enclaves. The assignment algorithms may also consider geographic distribution, hardware diversity, and trust relationships when determining the most appropriate compute enclaves for processing specific computation requests.

The trusted execution environment within each compute enclave assigned in step 404 may provide hardware-based security guarantees that enable secure processing of the encrypted inputs after decryption. In some cases, the trusted execution environment may utilize secure enclave technologies that create protected memory regions where computations may be performed without exposure to the host operating system or other software components. The assignment process may verify that the selected compute enclaves possess the necessary trusted execution environment capabilities to securely process the specific types of encrypted inputs included in the computation request.

The consensus requirement for compute enclave assignment in step 404 may involve the same threshold number of oracle nodes that participated in the authentication process during step 402. In some cases, the assignment consensus may require the oracle nodes to agree on both the selection of specific compute enclaves and the timing of request assignment to ensure coordinated processing. The consensus mechanism for enclave assignment may implement multiple rounds of communication between oracle nodes, where each round may refine the assignment decision based on feedback from participating nodes regarding enclave availability and suitability.

The authentication and assignment processes described in steps 402 and 404 may be implemented as atomic operations where both authentication and assignment decisions are finalized together to prevent inconsistencies between the authentication approval and the subsequent enclave assignment. In some cases, the atomic implementation may ensure that computation requests that pass authentication are immediately assigned to appropriate compute enclaves without intermediate states that could introduce security vulnerabilities or operational delays. The atomic processing approach may enhance the reliability and security of the confidential computing method by eliminating potential race conditions or coordination failures between the authentication and assignment phases.

The method may proceed to a step 406 where encrypted decryption key shares are generated for the assigned compute enclave by a plurality of decryption nodes holding shares of a master secret key. In some cases, the plurality of decryption nodes may collectively generate the encrypted decryption key shares without any single decryption node possessing complete access to the master secret key. The encrypted decryption key shares may enable decryption of only the encrypted inputs assigned to the at least one compute enclave, thereby implementing a strict need-to-know principle that limits potential exposure in case of compromise.

The generation of encrypted decryption key shares in step 406 may involve each decryption node applying its individual share of the master secret key to derive partial decryption keys for the specific encrypted inputs included in the computation request. In some cases, the partial decryption keys may be computed using threshold cryptographic protocols where each decryption node contributes its secret share to generate a portion of the complete decryption key material. The threshold approach may ensure that no single decryption node may independently generate complete decryption keys for the encrypted inputs.

The plurality of decryption nodes may be configured to generate a fresh public-private key pair at the at least one compute enclave for the computation request to enable forward-secure encryption. In some cases, the fresh key pair generation may occur at the initiation of each computation request, where the compute enclave may create a new asymmetric cryptographic key pair that remains valid only for the duration of that specific computation. The forward-secure encryption approach may ensure that compromise of a compute enclave at any given time may not enable decryption of encrypted inputs from previous or subsequent computation requests.

The fresh public-private key pair generation may utilize cryptographic algorithms such as elliptic curve cryptography or RSA-based methods to create secure key pairs within the trusted execution environment of the compute enclave. In some cases, the key generation process may incorporate hardware-based random number generators available within the trusted execution environment to ensure cryptographic randomness for the key material. The private key component of the fresh key pair may remain isolated within the trusted execution environment and may be automatically destroyed upon completion of the computation request to prevent unauthorized access to the key material.

The step 406 of generating the encrypted decryption key shares may comprise encrypting the decryption key shares using the fresh public key of the at least one assigned compute enclave. In some cases, each decryption node may encrypt its partial decryption key using the fresh public key provided by the assigned compute enclave, ensuring that only the compute enclave possessing the corresponding fresh private key may decrypt and access the key shares. The encryption process may create encrypted decryption key shares that are cryptographically bound to the specific compute enclave assigned to process the computation request.

The coordination between the plurality of decryption nodes and the assigned compute enclave during step 406 may involve secure communication protocols that enable distribution of the fresh public key from the compute enclave to all participating decryption nodes. In some cases, the fresh public key may be transmitted through authenticated channels that verify the identity of the compute enclave and ensure the integrity of the key material during distribution. The communication protocols may include cryptographic signatures or attestations that enable the decryption nodes to verify the authenticity of the fresh public key before using the key for encryption of the decryption key shares.

The encrypted decryption key shares generated in step 406 may be aggregated using cryptographic protocols that enable combination of multiple encrypted shares into a compact representation suitable for transmission to the assigned compute enclave. In some cases, the aggregation process may utilize mathematical properties of the threshold encryption scheme to combine encrypted shares without revealing the underlying key material to the aggregating parties. The aggregated encrypted decryption key shares may provide the compute enclave with the necessary cryptographic material to decrypt the assigned encrypted inputs while maintaining the security properties of the threshold encryption system.

The method continues to a step 408 where the computation algorithm is executed on decrypted inputs within the trusted execution environment of the at least one compute enclave. In some cases, the execution process in step 408 may begin with the compute enclave using its fresh private key to decrypt the encrypted decryption key shares received from the plurality of decryption nodes. The decrypted key shares may then be combined using threshold reconstruction techniques to recover the complete decryption keys for the encrypted inputs assigned to the computation request.

The decryption of the encrypted inputs during step 408 may be performed entirely within the trusted execution environment to ensure that the plaintext values of the encrypted inputs remain protected from external access throughout the computation process. In some cases, the trusted execution environment may provide hardware-based memory protection that prevents the host operating system, other software components, or external observers from accessing the decrypted input data. The isolation provided by the trusted execution environment may ensure that sensitive data remains confidential even when processed on potentially untrusted hardware platforms.

The execution of the computation algorithm in step 408 may involve processing the decrypted inputs according to the algorithm specification included in the original computation request. In some cases, the computation algorithm may perform mathematical operations, data transformations, logical computations, or other processing tasks that require access to the plaintext values of the encrypted inputs. The algorithm execution may utilize the computational resources available within the trusted execution environment while maintaining the security and isolation properties that protect the sensitive input data.

The computation algorithm execution during step 408 may incorporate deterministic randomness generation when the algorithm requires random values for proper operation. In some cases, the deterministic randomness may be generated using threshold verifiable random functions implemented by the plurality of decryption nodes to provide consistent random values that enable reproducible computation results. The deterministic approach may ensure that multiple compute enclaves executing the same computation request produce identical results, thereby supporting integrity verification mechanisms that compare outputs across different execution environments.

The trusted execution environment may implement memory management and data handling protocols during step 408 that ensure sensitive data is properly protected throughout the computation process and securely erased upon completion. In some cases, the memory management protocols may include automatic clearing of memory regions containing decrypted input data, intermediate computation results, and cryptographic key material when the computation algorithm execution is completed. The secure erasure mechanisms may prevent unauthorized recovery of sensitive data from memory after the computation request has been processed.

The method concludes with a step 410 where an attested response is generated from the at least one compute enclave. In some cases, the attested response generated in step 410 may include both the computation results and cryptographic attestation information that proves the computation was performed correctly within the trusted execution environment. The attestation may provide verifiable evidence that the computation algorithm was executed on the correct decrypted inputs and that the results were generated within a genuine trusted execution environment.

The generation of the attested response in step 410 may utilize hardware-based attestation mechanisms provided by the trusted execution environment to create cryptographic proofs of execution integrity. In some cases, the attestation mechanisms may generate digital signatures using hardware-protected attestation keys that are unique to the trusted execution environment and cannot be accessed by external software components. The attestation signatures may cover both the computation results and metadata about the execution environment, providing comprehensive verification capabilities for the computation process.

The attested response generated in step 410 may include encrypted computation results when the output data requires confidentiality protection similar to the input data. In some cases, the computation results may be encrypted using public keys provided by the requesting application or using the same threshold encryption infrastructure employed for the input data. The encrypted output approach may ensure that sensitive computation results remain protected during transmission back to the requesting application and may only be decrypted by authorized parties possessing appropriate decryption capabilities.

The attestation information included in the attested response from step 410 may contain verifiable metadata about the computation process, including identifiers of the trusted execution environment, timestamps of the computation execution, and cryptographic hashes of the computation algorithm and input data. In some cases, the attestation metadata may enable external parties to verify that the computation was performed correctly without requiring access to the sensitive input data or intermediate computation states. The verifiable metadata may support audit and compliance requirements while maintaining the confidentiality properties of the computation process.

The method may further comprise a step of performing proactive re-sharing of the master secret key shares among the plurality of decryption nodes at regular intervals, as described in more detail above.

The method for confidential computing may further comprise encrypted inputs that include associated data that binds each encrypted input to a specific application or decryption policy. The method may further comprise a step of verifying the associated data before generating the encrypted decryption key shares.

The verification of associated data may implement cryptographic proof mechanisms that enable the plurality of decryption nodes to verify policy compliance without revealing sensitive information about the encrypted inputs or the requesting applications. In some cases, the proof mechanisms may utilize zero-knowledge proof techniques that demonstrate compliance with decryption policies while preserving the confidentiality of the underlying data and application details. The cryptographic proofs may be generated by requesting applications and verified by the decryption nodes as part of the policy compliance assessment, enabling privacy-preserving verification of authorization requirements.

The compliance checking process may involve evaluation of request metadata to assess whether the computation request parameters align with the usage restrictions specified in the decryption policies. In some cases, the metadata evaluation may include analysis of the computation algorithm specification to confirm that the requested operations are permitted under the policy constraints, verification of the requesting application's authorization level, and assessment of whether the combination of encrypted inputs in the computation request complies with data combination restrictions that may be specified in the individual decryption policies.

The prevention of unauthorized decryption outside the intended context may be enforced through cryptographic binding mechanisms that make encrypted inputs computationally infeasible to decrypt when the associated data verification fails. In some cases, the binding mechanisms may incorporate application-specific cryptographic parameters into the encryption process, creating encrypted inputs that may only be decrypted when the correct application identifiers and policy parameters are provided during the decryption request. The cryptographic binding may utilize domain separation techniques that ensure encrypted inputs remain isolated between different applications and use cases, preventing cross-application access even when decryption capabilities are compromised.

The associated data structures may support hierarchical policy inheritance where encrypted inputs bound to parent applications or organizations may be accessible to authorized child applications within the same hierarchy. In some cases, the hierarchical policy structures may enable delegation of access rights where parent entities may grant specific permissions to subsidiary applications or organizational units. The inheritance mechanisms may utilize cryptographic key derivation techniques that enable child applications to derive appropriate decryption capabilities from parent-level authorizations while maintaining policy compliance and preventing unauthorized access outside the defined organizational boundaries.

The verification step may include policy conflict resolution mechanisms when encrypted inputs with different associated data requirements are included in the same computation request. In some cases, the conflict resolution may involve identifying the most restrictive policy requirements among all encrypted inputs and applying those restrictions to the entire computation request to ensure that no encrypted input is processed outside its intended policy context. The conflict resolution process may implement policy intersection algorithms that determine the common authorized parameters across all encrypted inputs, ensuring that the computation request complies with all applicable decryption policies simultaneously.

FIG. 5 illustrates a method for the use case of managing private token transactions to maintain confidentiality of account balances and transaction details while enabling standard token operations across multiple token types in accordance with disclosed implementations. The method may provide a comprehensive approach to private token management that preserves the privacy of balance information throughout deposit, transfer, and withdrawal operations. In some cases, the method 500 may utilize the confidential computing infrastructure to perform encrypted arithmetic operations on account balances without revealing actual balance amounts or transaction details to unauthorized parties.

The method may include maintaining an encrypted balance table within a private token contract at step 500. The encrypted balance table may store encrypted account balances for a plurality of addresses across multiple token types. In some cases, the encrypted balance table may serve as the central data structure for managing confidential token holdings, with each entry representing an encrypted account balance associated with a specific address and token type combination. The encrypted balance table may utilize threshold encryption schemes that ensure balance information remains confidential while enabling authorized operations through the confidential computing infrastructure.

The encrypted balance table may support simultaneous management of multiple token types within a unified private token contract system. In some cases, the multi-token support may enable users to hold and manage portfolios of different token types while maintaining privacy protection across all holdings. The encrypted balance table structure may include separate encrypted balance entries for each combination of address and token type, allowing for comprehensive token portfolio management within the confidential infrastructure while preserving the encryption properties of individual balance components.

At step 502 deposit operations are received from a plurality of native token contracts. In some cases, the step 502 may involve processing deposit requests that transfer tokens from external native token contracts into the private token contract system for confidential management. The deposit operations received in the step 502 may specify recipient addresses, token types, and deposit amounts that determine how the encrypted balance table should be updated to reflect the incoming token transfers.

The deposit operations received during the step 502 may include parameters that specify the recipient address within the private token contract system and the amount of tokens being deposited from each of the plurality of native token contracts. In some cases, the deposit operations may involve standard token transfer mechanisms where the native token contracts transfer specified amounts to the private token contract address while providing metadata that identifies the intended recipient within the encrypted balance table. The deposit process may utilize authentication mechanisms to verify the legitimacy of deposit operations and ensure that only authorized transfers are processed by the private token contract system.

The plurality of native token contracts that provide deposit operations in step 502 may represent different token standards and implementations that are integrated with the private token contract system. In some cases, the native token contracts may include ERC-20 tokens, ERC-721 tokens, or other blockchain-based token implementations that support transfer operations to the private token contract address. The integration mechanisms may enable seamless deposit operations from various token ecosystems while maintaining compatibility with existing token infrastructure and user interfaces.

At step 504, the encrypted balance table is updated to reflect increased encrypted account balances for recipient addresses specified in the deposit operations. In some cases, step 504 may involve encrypted arithmetic operations that add the deposited amounts to the existing encrypted balance entries without revealing the actual balance values or transaction amounts. The encrypted balance updates performed in step 504 may utilize the confidential computing infrastructure to ensure that balance modifications maintain the encryption properties throughout the update process.

The encrypted balance table updates performed during step 504 may involve lookup operations that identify the appropriate encrypted balance entry corresponding to the recipient address and token type specified in each deposit operation. In some cases, the lookup process may utilize encrypted address matching techniques that enable identification of the correct balance entry without revealing the actual address values to unauthorized parties. The encrypted balance table may support efficient lookup operations through cryptographic indexing mechanisms that preserve privacy while enabling rapid access to relevant balance entries during deposit processing.

The encrypted arithmetic operations implemented in step 504 may utilize homomorphic encryption properties or secure multi-party computation techniques to perform addition operations on encrypted balance values. In some cases, the encrypted addition operations may enable the private token contract to increase encrypted account balances by the deposited amounts without decrypting the existing balance values or the deposit amounts. The homomorphic arithmetic approach may ensure that balance updates maintain the confidentiality properties of the encrypted balance table while enabling accurate tracking of account balances across multiple deposit operations.

Step 504 may involve coordination with the confidential computing infrastructure to perform the encrypted balance updates within trusted execution environments that provide additional security guarantees for the arithmetic operations. In some cases, the balance update operations may be submitted as computation requests to the confidential computing system, where compute enclaves perform the encrypted arithmetic operations and return updated encrypted balance values. The integration with the confidential computing infrastructure may enhance the security properties of the balance update process while maintaining the privacy protection of the encrypted balance table throughout the deposit processing workflow.

At step 506, operations are received that specify source addresses, destination addresses, token types, and transfer amounts. Step 506 may involve processing transfer requests that enable movement of tokens between different addresses within the private token contract system while maintaining confidentiality of the transaction details. The transfer operations received in step 506 may include encrypted parameters that specify the source address from which tokens should be debited, the destination address to which tokens should be credited, the type of token being transferred, and the amount of tokens to be moved between the addresses.

The transfer operations received during step 506 may utilize encrypted addressing mechanisms that prevent unauthorized parties from learning the identities of the source and destination addresses involved in token transfers. In some cases, the source and destination addresses may be encrypted using the threshold encryption infrastructure to ensure that address information remains confidential throughout the transfer processing workflow. The encrypted addressing approach may enable private token transfers where external observers cannot correlate specific addresses with transfer activities, thereby providing transaction anonymity in addition to balance confidentiality.

The token type specifications included in the transfer operations during step 506 may identify which specific token from the plurality of supported token types should be transferred between the source and destination addresses. In some cases, the token type parameters may be encrypted to prevent unauthorized parties from learning which types of tokens are being transferred, thereby providing additional privacy protection for transaction activities. The encrypted token type approach may enable confidential portfolio management where users may transfer different token types without revealing their token holdings or transaction patterns to external observers.

The transfer amount parameters may be encrypted to prevent disclosure of the actual quantities of tokens being transferred between addresses. In some cases, the encrypted transfer amounts may utilize the same threshold encryption schemes employed for balance encryption to ensure consistency in the privacy protection mechanisms across all aspects of the private token system. The encrypted amount approach may enable confidential transaction processing where the specific values being transferred remain hidden from unauthorized parties while still enabling accurate balance updates through encrypted arithmetic operations.

Authentication mechanisms implemented during step 506 may verify that transfer operations are authorized by the holders of the source addresses before processing the requested token movements. In some cases, the authentication process may involve verification of encrypted digital signatures that demonstrate the source address holder's authorization for the specific transfer operation. The authentication mechanisms may utilize cryptographic protocols that enable verification of transfer authorization without revealing the identity of the authorizing party or the details of the transfer operation to unauthorized observers.

At step 508 the transfer operations are processed by decreasing encrypted account balances for the source addresses and increasing encrypted account balances for the destination addresses in the encrypted balance table while maintaining encryption of the balance information. Step 508 may involve coordinated encrypted arithmetic operations that ensure accurate balance updates across both source and destination addresses while preserving the confidentiality properties of the encrypted balance table throughout the transfer processing workflow.

The processing of transfer operations during step 508 may begin with encrypted balance verification procedures that confirm the source addresses possess sufficient encrypted account balances to satisfy the requested transfer amounts. In some cases, the balance verification may utilize encrypted comparison operations that determine whether the encrypted source balance exceeds the encrypted transfer amount without revealing the actual values to unauthorized parties. The encrypted comparison mechanisms may prevent insufficient balance transfers while maintaining the privacy protection of the balance information throughout the verification process.

The encrypted arithmetic operations performed during step 508 may utilize homomorphic encryption properties that enable subtraction operations on the encrypted source address balances and addition operations on the encrypted destination address balances. In some cases, the homomorphic arithmetic approach may allow the private token contract to perform accurate balance updates without decrypting any of the balance values or transfer amounts involved in the transaction. The homomorphic operations may ensure that the encryption properties of the balance table remain intact throughout the transfer processing while enabling precise tracking of token movements between addresses.

The coordination mechanisms implemented during step 508 may ensure that the decrease in encrypted account balances for source addresses and the increase in encrypted account balances for destination addresses occur atomically to prevent inconsistent balance states. In some cases, the atomic processing approach may utilize transaction mechanisms that guarantee both balance updates complete successfully or both updates are reverted to maintain the integrity of the encrypted balance table. The atomic coordination may prevent partial transfer states that could result in token loss or double-spending scenarios within the private token system.

The encrypted balance updates performed during step 508 may involve coordination with the confidential computing infrastructure to execute the arithmetic operations within trusted execution environments that provide additional security guarantees for the balance modification process. In some cases, the balance update operations may be submitted as computation requests to compute enclaves that perform the encrypted arithmetic operations and return updated encrypted balance values for both source and destination addresses. The integration with trusted execution environments may enhance the security properties of the transfer processing while maintaining the confidentiality of all balance information throughout the operation. Step 508 may include encrypted audit trail mechanisms that record transfer operation details for compliance and verification purposes without revealing the actual transaction amounts or address identities to unauthorized parties.

At step 510 where encrypted responses are generated to balance inquiry operations without revealing actual balance amounts to unauthorized parties. In some cases, the step 510 may involve processing balance query requests that enable authorized parties to access encrypted balance information while maintaining confidentiality from unauthorized observers. The encrypted responses generated during step 510 may utilize viewing key mechanisms that enable selective decryption of balance information by parties possessing appropriate authorization credentials.

The balance inquiry operations processed during step 510 may include parameters that specify the address and token type for which balance information is being requested, along with authentication credentials that demonstrate the requesting party's authorization to access the encrypted balance data. In some cases, the balance inquiry parameters may be encrypted to prevent unauthorized parties from learning which addresses or token types are being queried, thereby providing additional privacy protection for the inquiry process itself. The encrypted parameter approach may ensure that balance inquiry activities remain confidential even when the inquiry requests are transmitted through potentially observable communication channels.

The encrypted responses generated during step 510 may utilize threshold encryption mechanisms where the encrypted balance information may only be decrypted by parties possessing appropriate viewing keys derived from the threshold encryption infrastructure. In some cases, the viewing key generation process may require collaboration among a minimum number of decryption nodes to ensure that no single node may independently grant access to encrypted balance information. The threshold approach may provide distributed control over balance information access while enabling authorized parties to decrypt balance data when appropriate authorization requirements are satisfied.

The access control mechanisms implemented during step 510 may include role-based authorization systems that determine which parties are permitted to access encrypted balance information for specific addresses and token types. In some cases, the role-based access control may enable account holders to grant viewing permissions to designated parties such as auditors, compliance officers, or authorized representatives without providing complete access to all balance information. The granular access control approach may enable selective disclosure of balance information based on specific authorization requirements and regulatory compliance needs.

The encryption protocols employed during step 510 may utilize hierarchical encryption schemes that enable derivation of viewing keys for specific balance inquiries while maintaining cryptographic separation between different viewing contexts. In some cases, the hierarchical approach may allow authorized parties to derive viewing keys for related balance queries without requiring separate authorization processes for each individual inquiry. The hierarchical encryption mechanisms may enhance the efficiency of balance inquiry processing while preserving the security properties of the access control system.

The encrypted responses generated during step 510 may include temporal restrictions that limit the validity period of the encrypted balance information to prevent unauthorized reuse of balance data across extended time periods. In some cases, the temporal restrictions may be enforced through cryptographic mechanisms that automatically invalidate encrypted balance responses after predetermined time intervals or specific usage conditions. The temporal limitation approach may enhance the security of balance information disclosure while enabling authorized parties to access current balance data when appropriate authorization requirements are satisfied.

Step 510 may implement encrypted response verification mechanisms that enable requesting parties to confirm the authenticity and integrity of the encrypted balance information without revealing the actual balance amounts to unauthorized observers. In some cases, the verification mechanisms may utilize cryptographic signatures or attestations that demonstrate the encrypted responses were generated correctly by the private token contract system. The verification approach may provide assurance of balance information accuracy while maintaining the confidentiality properties of the encrypted response generation process.

The unauthorized party protection mechanisms implemented during step 510 may utilize cryptographic binding techniques that ensure encrypted balance responses may only be decrypted by parties possessing the correct viewing keys and authorization credentials. In some cases, the binding mechanisms may incorporate identity-based encryption parameters that cryptographically link encrypted responses to specific authorized recipients, preventing unauthorized decryption even if the encrypted response data is intercepted during transmission. The cryptographic binding approach may provide strong protection against unauthorized access to balance information while enabling legitimate authorized access through proper authentication channels.

The balance inquiry processing during step 510 may support batch query operations that enable authorized parties to request encrypted balance information for multiple addresses or token types within a single inquiry operation. In some cases, the batch processing approach may improve the efficiency of balance inquiry operations while maintaining the privacy protection and access control mechanisms for each individual balance query within the batch. The batch inquiry capabilities may enable comprehensive balance reporting for authorized parties such as auditors or compliance officers while preserving the confidentiality of the underlying balance information throughout the inquiry process.

The encrypted response generation mechanisms implemented during step 510 may coordinate with the confidential computing infrastructure to perform balance lookup and encryption operations within trusted execution environments that provide additional security guarantees for the inquiry processing workflow. In some cases, the balance inquiry operations may be submitted as computation requests to compute enclaves that access the encrypted balance table, perform authorized balance lookups, and generate encrypted responses using the appropriate viewing key mechanisms. The integration with trusted execution environments may enhance the security properties of the balance inquiry process while maintaining the confidentiality of the encrypted balance table throughout the response generation workflow.

One way to instantiate the protocol is by combining a standard threshold public-key encryption (tPKE) scheme with an interactive forward-secure encryption scheme. Options for the latter are using a standard public-key encryption scheme with one-time key pairs, i.e., using each public key only to encrypt a single message, or an interactive forward-secure key agreement protocol like TLS 1.3, and create a fresh session for each message. (The resumption feature in TLS 1.3 allows zero round-trip time (ORTT) forward-secure encryption, without needing a fresh interactive handshake to take place.)

A tPKE scheme consists of:
(pk,vk,(sk₁, . . . , skₙ))←_{$}DKG(n,t): a distributed key generation protocol that the n decryption nodes perform so that any t of them can jointly decrypt ciphertexts. The protocol results in a public encryption key pk, a public verification key vk, and secret key shares sk₁, . . . , skₙ for decryption nodes 1, . . . , n, respectively.
c←_{$}Encrypt(pk,m,L): an encryption algorithm that, on input a public key pk, a message m, and an encryption label L outputs a ciphertext c.
dkᵢ←_{$}KeyDer(skᵢ,c,L): an encrypted share generation algorithm that enables decryption node i, on input his secret key share skᵢ, a ciphertext c, and an encryption label L outputs a decryption key share dkᵢ.
0/1←SVerify(vk,c,dkᵢ): a share verification algorithm that, on input a public key pk, a ciphertext c, the verification key vk, and a decryption key share dkᵢ, outputs 1 to indicate that dkᵢ is a valid decryption key share by decryption node i for c, or outputs 0 if not.
m←Decrypt(c,L,DK): a decryption algorithm that, on input a ciphertext c, encryption label L, and a set of valid decryption key shares DK from t different decryption nodes, outputs the message m or a rejection symbol ⊥.

In terms of bandwidth efficiency, a compute enclave evaluating a request involving b ciphertexts will need (t₁+t₂)·b valid decryption key shares to decrypt all ciphertexts. Given that up to t₁−1 key nodes and t₂−1 key enclaves can be corrupted, however, that means that the enclave may need up to (2t₁+2t₂−2)b encrypted decryption keys to be sure that it can decrypt all ciphertexts.

In some use cases, it may be clear at the time of encryption which ciphertexts will end up as a batch in a Chainlink Confidential Compute request. For example, all encrypted bids for an auction in a sealed-bid auction application will likely end up together in a batch, as will be all votes in for the same secret election. An identity-based encryption (IBE) scheme [Sha84, BF01] lets users encrypt to a master public key and an “identity”, which can be an arbitrary string. The master authority can derive a decryption key for a particular identity, which can be used to decrypt all ciphertexts encrypted to that identity. A threshold identity-based encryption (tIBE) scheme [BF01] decentralizes the power of the master authority, so that a threshold number of authorities are needed to derive a decryption key.

It is known to use an extension whereby the authorities not only derive decryption keys for identities, but also for individual ciphertexts. Referring to such schemes as dual threshold identity-based encryption (dtIBE) schemes here, their syntax is similar to that of tPKEs, except that
c←_{$}Encrypt(pk,id,m,L): encryption now also takes an identity as additional input,
cdkᵢ←_{$}KeyDerC(skᵢ,c,id,L), 0/1←SVerifyC(vk,id,c,cdkᵢ): there are now two separate key derivation and share verification algorithms, those for individual ciphertexts as in tPKE, but which now additionally take an identity as input,
idkᵢ←_{$}KeyDerID(skᵢ,id), 0/1←SVerifyID(vk,id,idkᵢ); and those to derive identity keys, which take an identity but no ciphertext as inputs.

The syntax of the decryption algorithm can remain unchanged, if we assume that the set of decryption key shares DK can be either a set of ciphertext decryption key shares for that ciphertext, or a set of identity decryption key shares for the identity under which this ciphertext was encrypted. By cleverly choosing identity strings (e.g., using an identifier for the auction or election in the examples above), some use cases may be able to reduce the number of decryption key shares that need to be handed to the compute enclave to t₁+t₂ valid shares, or 2t₁+2t₂−2 encrypted shares.

The schemes above are secure, but have some drawbacks. First, it requires the TEE to keep track of which decryption nodes have provided valid decryption key shares for which request. Secure enclaves typically can't hold much internal state information, however. They can use external encrypted (“sealed”) storage on an untrusted host, but unless expensive oblivious random-access memory (ORAM) [GO96] techniques are used, the access patterns may act as a side channel, leaking information about the computations inside the enclave. External storage may also open up the possibility of replay attacks, by running the enclave on an old copy of the sealed state.

Alternatively, the untrusted host machine that runs the enclave could cache encrypted shares until sufficiently many have been collected to execute the request. Bad decryption nodes can provide bogus shares, though, so the host will either need a negotiation protocol with the enclave to weed out bad shares, or have to wait for 2t₁+2t₂−1 encrypted shares, instead of the t₁+t₂ that are strictly required, to ensure that there are t₁+t₂ valid shares among them, harming latency and excluding honest-majority thresholds t₁>n₁/2, t₂>n₂/2.

In terms of bandwidth, a request involving b ciphertexts requires at least b(t₁+t₂) encrypted tPKE decryption key shares to be handed to the enclave, or t₁+t₂ tIBE shares for “well-coordinated” requests. One idea would be to aggregate encrypted shares before handing them to the enclave; because the shares are encrypted to the compute enclave, however, the host cannot perform any aggregation, or even check their validity to know which shares to validate.

Applicants propose two new schemes that enable an untrusted host to verify and aggregate encrypted decryption shares, without learning anything about the encrypted share or the ciphertexts' contents, considerably reducing the enclave's bandwidth requirements and simplifying its internal bookkeeping. The first is a verifiable encrypted threshold public-key encryption (vetPKE) scheme. Using it, a request with b independently created ciphertexts only needs b encrypted keys of two group elements each. The second is a dual verifiably encrypted threshold hierarchical identity-based encryption (dvetHIBE) scheme, allowing compact decryption keys to be derived both for individual ciphertexts or for hierarchically structured identity vectors. This offers even more flexibility to structure ciphertexts that need to be decrypted together. A well-coordinated requests with ciphertexts that are encrypted to descendants of the same identity vector only need a single compact encrypted decryption key to execute the request.

The syntax of a vetPKE scheme is similar to that of a tPKE scheme, except that
(rpk,rsk)←_{$}RKG( ): there is a separate key generation algorithm for recipients of decryption keys, generating public-secret key pairs (rpk,rsk);
edkᵢ←_{$}EKeyDer(skᵢ,c,L,rpk): the encrypted key derivation algorithm takes a recipient's public key rpk as an additional input and produces an encrypted decryption key share edkᵢ;
0/1←ESVerify(vk,c,edkᵢ,rpk): an encrypted share verification algorithm can verify that edkᵢ contains a valid decryption key share by decryption node i for a ciphertext c encrypted under a receiver's public key rpk;
m←Decrypt(c,L,EDK,rsk): and the decryption algorithm takes a threshold number of valid encrypted decryption key shares EDK and the recipient's secret key as an additional input to recover the encrypted message m.
   An aggregatable vetPKE scheme additionally has the following algorithms:
edk←Aggregate(EDK): anyone can combine a set of valid encrypted decryption shares EDK by an authorized subset of decryption nodes to a compact encrypted decryption key edk;
0/1←EVerify(vk,c,edk,rpk): there is an additional algorithm to verify aggregate encrypted decryption keys;
m←Decrypt(c,L,edk,rsk): and the decryption algorithm takes a the recipient's secret key as an additional input to recover the encrypted message m.

A forward-secure encryption to the recipient is not required; such a property can always be achieved by letting the recipient generate a one-time key pair for each ciphertexts that needs to be decrypted.

Two vetPKE schemes are expressly described herein. The first construction, called vetDH2, is a variant of the Shoup-Gennaro TDH2 scheme, whereby the decryption key shares, rather than being revealed in the clear, are ElGamalencrypted to the recipient, together with a zero-knowledge proof of membership that the ElGamal ciphertext indeed contains the correct decryption key. The recipient is guaranteed to be able to decrypt the ciphertext given a threshold number of encrypted decryption shares with a valid zero-knowledge proof.

The second construction, called avetDH2, is based on pairings and has the additional advantage that encrypted decryption shares can be aggregated, meaning that anyone can combine a threshold of valid encrypted decryption shares into a single, compact encrypted decryption key for that ciphertext. The idea to ElGamal-encrypt decryption key shares is related to that of Boneh et al.'s verifiably encrypted signatures and Cerulli et al.'s verifiably encrypted threshold key derivation (vetKeys), namely to ElGamal-encrypt the decryption key share under the recipient's public key. Rather than proving the correctness of the (encrypted) key share in zero-knowledge, as is done in the original vetDH2 scheme, the pairing can be used to perform this check. This allows the aggregation of encrypted key shares (by Lagrange interpolation in the exponent), because the zero-knowledge proofs would not be (easily) aggregatable, but the pairing verification can still be performed on the aggregated encrypted decryption key.

The vetDH2 scheme uses a multiplicative cyclic group G of prime order q with random generators g, g and three hash functions H₁:

$$G \to {\{ 0 , 1 \}}^{l} , {H}_{2} : {\{ 0 , 1 \}}^{l} \times {\{ 0 , 1 \}}^{lL} \times {G}^{4} \to E , and {H}_{3} : {\{ 0 , 1 \}}^{l} \times {G}^{2} \times E \times Zq \times {\{ 0 , 1 \}}^{lL} {G}^{7} \to E ,$$

where E⊆Zq.
   Let f(x)∈F[x] be a polynomial of degree t−1 over a field F. Let {Λ_{i,S}(x): S⊆F, |S|=t, i∈S} be the set of Lagrange basis polynomials for S, i.e., the set of unique polynomials of degree t−1 such that Λ_{i,S}(i)=1 and Λ_{i,S}(j)=0 for all j∈S\{i}, namely

$${Λ}_{i , S} ( x ) = {\prod }_{j ∈ S \backslash \{ i \}} \frac{x - j}{i - j} .$$

Then f(x) can be rewritten as its Lagrange interpolation polynomial as

$$f ( x ) = {}^{X} f ( i ) \cdot {Λ}_{i , S} ( x ) .$$

$$i ∈ S$$

The DKG protocol is described herein as if it were executed by a trusted dealer with a secure connection to all decryption nodes. In reality, one would use an actual distributed key generation algorithm with at least t dealers.

The trusted dealer chooses a random polynomial f(x)=a₀+a₁·x+ . . . +aₜ₋₁·x^{t-1}∈Zq[x] of degree t−1. It computes xᵢ←f(i) and hᵢ←g^{xi} for i=0, . . . , n. It sets the public key pk to h=h₀, the verification key vk to (h₁, . . . , hₙ), and sends xᵢ as the secret key skᵢ to decryption node i.

Encryption can be identical to the TDH2 scheme by Shoup and Gennaro. To encrypt a message m∈{0, 1}^{l} with label L, the sender ElGamalencrypts m as

$$u ← {g}^{r} , c ← {H}_{1} ( {h}^{r} ) ⊕ m ,$$

for r←_{$}Zq, computes u ←g ^{r}
and creates a non-interactive zero-knowledge proof that log_{g} u=log_{g}−u\hat{ } as

$$w ← {g}^{s} , {w}^{-} ← {g}^{{-}_{s}}$$

$$e ← {H}_{2} ( c , L , u , w , u {,}^{-} {w}^{-} ) f ← s + r e$$

for s←_{$}Zq. The ciphertext is c=(c,u,u,e,f ).
   The recipient chooses a secret key rsk←_{$}Zq and computes its public key as rpk←g^{rsk}.

Decryption node i creates an encrypted decryption key share for ciphertext c=(c,u,u,e,f ) as follows. First, it verifies the zero-knowledge proof in c by re-computing

$$w ← {g}^{f} / {u}^{e} , {w}^{-} ← {g}^{{-}_{f}} / {u}^{{-}_{e}} \qquad ( 1 )$$

and checking that

$$e = {H}_{2} ( c , L , u , w , {u}^{-} {w}^{-} ) . \qquad ( 2 )$$

It then ElGamal-encrypts its decryption share uᵢ=u^{xi} to the recipient's public key as

$$v i ← g r i , d i ← rpkri \cdot ui$$

and adds a zero-knowledge proof that (vᵢ,dᵢ) is a correct encryption of its correct decryption key share, i.e., that

$$di = rpk log g vi \cdot u log g hi$$

as

$${d}^{\hat{}} i ← rpksi , 1 \cdot usi , 3 {v}^{\hat{}} i ← gsi , 1$$

$${h}_{i}^{\hat{}} ← {g}^{s} i , 2$$

$${e}_{i} ← {H}_{3} ( c , rpk , {d}_{i} , {v}_{i} , {h}_{i} , {d}_{i}^{\hat{}} , {v}_{i}^{\hat{}} , {h}_{i}^{\hat{}} ) fi , 1 ← si , 1 + rieifi , 2 ← si , 2 + xiei .$$

for s_{i,1},s_{i,2}←_{$}Zq. The encrypted decryption share is given by σ=(i,di,vi,ei,fi,1,fi,2).

Anyone can verify that σ=(i,dᵢ,vᵢ,eᵢ,f_{i,1},f_{i,2}) is a valid encrypted decryption key share for ciphertext c=(c,u,u,e,f ) by obtaining hᵢ from the verification key vk and verifying the zero-knowledge proof in σ by re-computing

$${d}^{\hat{}} i ← rpkfi , 1 \cdot ufi , 2 / deii \qquad ( 3 )$$

$${\hat{v}}_{i} ← {ℊ}^{{f}_{i , 1}} / {v}_{i}^{{e}_{i}} \qquad ( 4 )$$

$${\hat{h}}_{i} ← {ℊ}^{{f}_{i , 2}} / {h}_{i}^{{e}_{i}} , \qquad ( 5 )$$

and checking that

$${e}_{i} = {H}_{3} ( c , rpk , {d}_{i} , {v}_{i} , {h}_{i} , {d}_{i}^{\hat{}} , {v}_{i}^{\hat{}} , {h}_{i}^{\hat{}} ) .$$

The combiner uses a set of t valid shares Σ by decryption nodes i∈S to decrypt a ciphertext c=(c,u,u,e,f ) by first verifying the zeroknowledge proof in c as in Equations (1) and (2); if this fails, it outputs ⊥.

It then combines the individual encrypted shares into a single ElGamal ciphertext encrypting u^{x} as

$$d ← Q ( i , d i , … ) ∈ Σ d Λ i i , S ( 0 )$$

$$v ← Q ( i , \cdot , vi , … ) ∈ Σ vi Λ i , S ( 0 )$$

and uses it to decrypt c as

$$m ← c ⊕ {H}_{1} ( d / {v}^{r s k} ) .$$

Another possible scheme is the aggregatable avetDH2 scheme. We assume a pairing-friendly curve with multiplicative groups G1, G2, Gt of prime order q and with generators g1, g2 of G1, G2, respectively, over which an efficiently computable bilinear map e: G1×G2→Gt is defined. It also uses two hash functions H₁:
G1→{0,1}^{l} and H³:

$${\{ 0 , 1 \}}^{l} \times {\{ 0 , 1 \}}^{{l}_{L}} \times {𝔾}_{1}^{4} \to ε ,$$

where
E⊆Zq.

The DKG protocol described herein as if it were executed by a trusted dealer. The trusted dealer chooses a random polynomial

f(x)=a₀+a₁·x+ . . . +aₜ₋₁·x^{t-1∈}Zq[x] of degree t−1.

It computes xᵢ←f(i) for

$$i = 0 , … , n , {h}_{1 , 0} ← {ℊ}_{1}^{{x}_{0}} , and {h}_{2 , i} ← {ℊ}_{2}^{{x}_{1}}$$

for i=0, . . . , n. It sets the public key pk to (h_{1,0}h_{2,0},g ₁), where g₁ is a random generator of G1, the verification key vk to (h_{2,1}, . . . , h_{2,n}), and sends xᵢ as the secret key skᵢ to decryption node i.

To encrypt a plaintext m, the sender computes

$$u ← {ℊ}_{1}^{r} , c ← {H}_{1} ( {h}_{1 , 0}^{r} ) ⊗ m ,$$

for r←_{$}Zq, computes

$$\overline{u} ← {\overline{ℊ}}_{1}^{r}$$

and creates a non-interactive zero-knowledge proof that log_{g} u=log_{g 1}u as

$$w ← {g}_{1}^{s} , {w}^{-} ← {g}_{{1}^{s}}^{-}$$

$$e ← {H}_{2} ( c , L , u , w , {u}^{-} {w}^{-} ) f ← s + r e$$

for s←_{$}Zq. The ciphertext is c=(c,u,u,e,f ).

The recipient chooses a secret key rsk←_{$}Zq and computes its public key as

$$rpk ← ( {rpk}_{1} , {rpk}_{2} ) = ( {ℊ}_{1}^{rsk} , {ℊ}_{2}^{rsk} ) .$$

Decryption node i creates an encrypted decryption share for ciphertext c=(c,u,u,e,f ) as follows. First, it verifies the zero-knowledge proof in c by re-computing

$$w ← {ℊ}_{1}^{f} / {u}^{e} , \overline{w} ← {\overline{ℊ}}_{1}^{f} / {\overline{u}}^{e} \qquad ( 6 )$$

and checking that

$$e = {H}_{2} ( c , L , u , w , u {,}^{-} {w}^{-} ) . \qquad ( 7 )$$

It then ElGamal-encrypts its decryption share uᵢ=u^{xi} to the combiner's public key as

$${v}_{i} ← {ℊ}_{l}^{{r}_{i}} , {d}_{i} ← {rpk}_{l}^{{r}_{i}} \cdot {u}_{i} .$$

The encrypted decryption share is given by edkᵢ=(i,dᵢ,vᵢ). Anyone can verify that edkᵢ=(i,dᵢ,vᵢ) is a valid encrypted decryption share for ciphertext c=(c,u,u,e,f ) by obtaining h_{2,i} from the verification key vk and verifying that

$$e ( {d}_{i} , {g}_{2} ) = e ( {v}_{i} , {rpk}_{2} ) \cdot e ( u , {h}_{2 , i} ) .$$

The aggregator uses a set of t valid shares edkᵢ=(i,dᵢ,vᵢ) by decryption nodes i∈S to create a compact aggregated encrypted share edk=(d,v) as

$$d ← {Q}_{i ∈ S} d {Λ}_{i} i , S ( 0 ) v ← {{Q}_{i ∈ S}}_{i}^{v} Λ i , S ( 0 ) .$$

Anyone can verify that edk=(d,v) is a valid aggregated encrypted decryption share for ciphertext c=(c,u,u,e,f ) by verifying that

$$e ( d , {g}_{2} ) = e ( v , {rpk}_{2} ) \cdot e ( u , {h}_{2 , 0} ) .$$

The recipient decrypts a ciphertext c=(c,u,u,e,f ) by first verifying the zero-knowledge proof in c as in Equations (6) and (7); if this fails, it outputs ⊥. It then decrypts c as m←c⊕H₁(d/v^{rsk}).

We now present a scheme that combines the advantages of verifiably encrypted key derivation with the flexibility of a dual threshold IBE scheme. Even more flexibility to ensure that queries contain well-coordinated ciphertexts can be obtained by generalizing the idea to a hierachical IBE. Here, identities are defined as vectors of strings (id₁, . . . , [symbol] )∈({0,1}* [symbol] , so that a ciphertext encrypted to an identity vector id=(id₁, . . . , [symbol] ) can be decrypted by a key derived for any “ancestor” identity id=(id₁, . . . , [symbol] ), 1≤ [symbol] ≤ [symbol] .

This provides better “structure” to the ciphertexts, so that more requests include a batch of ciphertexts that can be derived from a single identity key, rather than several per-ciphertext keys. For example, the oracle nodes could insist that the first identity vector be set to the application identifier (e.g., the concatenation of the blockchain and smart contract that created the request), while the remaining levels in the hierarchy are left for the application developer to determine.

The main idea here is similar to the identity-based encryption with verifiably encrypted key derivation (vetIBE) by Cerulli et al., where threshold shares of identity-based decryption keys are verifiably encrypted to a recipient. The dvetHIBE scheme extends this idea in two ways. First, it generalizes it to a hierarchical identity-based encryption scheme, instead of a (single-level) IBE. Second, it adds “dual” key derivation, meaning that keys can be derived for a particular identity as well as for a particular ciphertext; the vetIBE of [CCN⁺23] misses the latter functionality.

The dual verifiably encrypted threshold hierarchical identity-based encryption (dvetHIBE) is based on the Gentry-Silverberg HIBE with a generalization of vetKeys key derivation and Shoup-Gennaro threshold public-key encryption. Note that, when restricted to a single-level identity. It uses a pairing-friendly curve with multiplicative groups G1, G2, Gt of prime order q with generators g₁,g₂ of G1,G2, respectively, and an efficiently computable bilinear map e: G1×G2→Gt. It also uses hash functions
H₀: ({0,1}*)^{≥L}→G1, H₁: Gt→{0,1}^{l}, and H₂:

$${\{ 0 , 1 \}}^{l} \times {\{ 0 , 1 \}}^{lL} \times {( {\{ 0 , 1 \}}^{*} )}^{\leq L} \times {𝔾}_{1}^{4} \times {𝔾}_{2}^{\leq 2 L - 2} \to ε , where ε ⊆ {ℤ}_{q} .$$

Let L be the maximal hierarchy depth, meaning that identity vectors are of the form (id₁, . . . , [symbol] ) with id₁, . . . , [symbol] ∈{0, 1}* and [symbol] ≤L.

The trusted dealer chooses a random polynomial f(x)=a₀+a₁·x+ . . . +aₜ₋₁·x^{t-1}∈Zq[x] of degree t−1. It computes xᵢ←f(i) for i=0, . . . , n, and

$${h}_{i , 1} ← {ℊ}_{1}^{{x}_{i}} , {h}_{2 , i} ← {ℊ}_{2}^{{x}_{i}}$$

for i=0, . . . , n. It sets the master public key mpk to (h_{1,0},h_{2,0},g 2), where g₂ is a random generator of G2, the verification key vk to (h_{1,1}, h_{2,1}, . . . , h_{1,n}, h_{2,n}), and sends xᵢ as the secret key skᵢ to decryption node i.

To encrypt message m to identity vector (id₁, . . . , [symbol] ), the sender computes

$$u ← {ℊ}_{2}^{r} , c ← {H}_{1} ( e ( {H}_{0} ( ( {id}_{1} ) ) , {h}_{2 , 0}^{r} ) ) ⊗ m ,$$

for r←_{$}Zq, computes

$${u}^{-} ← {g}_{{2}^{r}}^{-}$$

$${u}_{j} ← {{H}_{0} ( ( i {d}_{1} , … , i {d}_{j} ) )}^{r} for j = 2 , … , ℓ$$

and creates a non-interactive zero-knowledge proof that log_{g2} u=log_{g 2} u =log H₀((id₁, . . . , idⱼ)) u^{j} as

$$w ← {g}_{2}^{\text{?}} , {w}^{\text{?}} ← {g}_{2}^{\text{?}}$$

$${w}_{j} ← {{H}_{0} ( ( i {d}_{1} , … , i {d}_{j} ) )}^{s} for j = 2 , … , ℓ e ← {H}_{2} ( c , L , ( i {d}_{1} , … , {id}_{ℓ} ) , u , w , {u}^{-} , w , {u}_{2}^{-} , … , {u}_{ℓ} , {w}_{2} , … , {w}_{ℓ} )$$

$$f ← s + r e$$

$$\text{?} \text{indicates text missing or illegible when filed}$$

for s←_{$}Zq. The ciphertext is c=(c, u, u, u ₂, . . . , [symbol] ).

The recipient chooses a secret key rsk←_{$}Zq and computes its public key as

$$rpk ← ( {rpk}_{1} , {rpk}_{2} ) = ( {g}_{1}^{\text{?}} , {r}_{2}^{\text{?}} ) .$$

$$\text{?} \text{indicates text missing or illegible when filed}$$

The full decryption key for identity (id₁, . . . , [symbol] ) is given by a tuple (k₀, . . . , [symbol] ) where

$$ℓ - 1$$

$$k 0 = H 0 ( ( id 1 ) ) x 0 \cdot Y H 0 ( ( id 1 , … , idj + 1 ) ) tj$$

$$j = 1$$

$${k}_{\text{?}} = {g}_{2}^{\text{?}} for 1 , … , ℓ - 1 ,$$

$$where {t}_{1} , … , {t}_{ℓ - 1} ← {}_{\$} Zq .$$

$$\text{?} \text{indicates text missing or illegible when filed}$$

To derive such decryption keys in a verifiably encrypted and threshold manner, decryption node i chooses rᵢ, t_{1,i}, . . . , [symbol] ←_{$}Zq and computes

$${v}_{\text{?}} ← {g}_{1}^{\text{?}}$$

$$ℓ - 1$$

$${k}^{⋀} 0 , i ← rpkr 1 i \cdot H 0 ( ( id 1 ) ) xi \cdot Y H 0 ( id 1 , … , idj + 1 ) ) tj , i$$

$$j = 1 {k}_{\text{?}} ← {g}_{2}^{\text{?}} for j = 1 , … , ℓ - 1.$$

$$\text{?} \text{indicates text missing or illegible when filed}$$

The encrypted key share is given by eikᵢ=(i, vᵢ, k\hat{ }_{0,i}, k_{1,i}, . . . , [symbol] ).

Anyone can verify that eikᵢ=(i, vᵢ, k\hat{ }_{0,i}, k_{1,i}, . . . , [symbol] ) is a valid encrypted key share for identity (id₁, . . . , [symbol] ) and recipient rpk=(rpk₁,rpk₂) by verifying that

$$e ( {k}_{0 , i}^{⋀} , {g}_{2} ) = e ( {v}_{i} , {rpk}_{2} ) \cdot e {H}^{0 ( ( {id}_{1} ) ) , {h}_{2 , i} )} \cdot {\prod }_{j = 1}^{ℓ - 1} e {H}^{\text{?} ( ( {id}_{1} , … , {id}_{j + 1} ) ) , {k}_{j , i} )} .$$

$$\text{?} \text{indicates text missing or illegible when filed}$$

A set of t valid encrypted identity key shares {eikᵢ: i∈S} for S⊆{1, . . . ,n}, |S|=t, can be aggregated into a compact encrypted key eik=(v, k\hat{ }₀, k₁, . . . , [symbol] ) as

$$v ← {Y}_{i}^{v} Λ i , S ( 0 )$$

$$i ∈ S$$

$${k}^{⋀} 0 ← {Y}^{⋀} {Λ}_{i , S} ( 0 )$$

$$k 0 , i$$

$$i ∈ s$$

$${k}_{j} ← \prod {k}_{j , i}^{{Λ}_{\text{?}} ( 0 )} for j = 1 , … , ℓ - 1.$$

$$i ∈ S$$

$$\text{?} \text{indicates text missing or illegible when filed}$$

An (aggregated) encrypted identity key eik=(v, k\hat{ }₀, . . . , [symbol] ) can be verified to contain a valid decryption key for
(id₁, . . . , [symbol] ) encrypted under rpk=(rpk₁,rpk₂) by checking that

$$e ( {k}_{0}^{⋀} , {g}_{2} ) = e ( v , {rpk}_{2} ) \cdot e {H}^{\text{?} ( ( {id}_{1} ) ) , {h}_{2 , 0} )} \cdot {\prod }_{j = 1}^{ℓ - 1} e {H}^{1 ( ( {id}_{1} , … , {id}_{j + 1} ) ) , {k}_{j} )} . \qquad ( 8 )$$

$$\text{?} \text{indicates text missing or illegible when filed}$$

To decrypt a ciphertext c=(c, u, u, u ₂, . . . , [symbol] ) for identity (id₁, . . . , [symbol] ) using an encrypted identity key eik=(v, k₀, . . . , [symbol] ) for identity (id₁, . . . , [symbol] ), [symbol] , the recipient first verifies the zeroknowledge proof in the ciphertext by re-computing

$$w ← {g}_{2}^{f} / {u}^{\text{?} \text{?}} , {w}^{\text{?}} ← {{g}^{\text{?}}}_{2}^{f} / {{u}^{\text{?}}}^{\text{?}} \qquad ( 9 )$$

$${w}_{j} ← H ( ( {id}_{1} , … , {id}_{j} ) ) f / {u}_{j}^{e} for j = 2 , … , ℓ \qquad ( 10 )$$

$$\text{?} \text{indicates text missing or illegible when filed}$$

and checking that

$$e = {H}_{2} ( c , L , ( i {d}_{1} , … , {id}_{ℓ}^{′} ) , u , w , {u}^{-} , w , {u}_{2}^{-} , … , {u}_{ℓ} , {w}_{2} , … , {w}_{ℓ} ) . \qquad ( 11 )$$

It also verifies the encrypted key using Equation (8). If any of these fail, the recipient aborts. Otherwise, it recovers the decryption key (k₀, . . . , [symbol] ) for (id₁, . . . , [symbol] ) by computing k0←k\hat{ }0/vrsk
and, if [symbol] , extends it to a decryption key (d₀, . . . , [symbol] ) for (id₁, . . . , [symbol] ) by choosing [symbol] , . . . , [symbol] and computing

$$ℓ - 1$$

$$k 0 ← k 0 \cdot Y H 0 ( ( id 1 , … , idj + 1 ) ) tj$$

$$j = {ℓ}^{′} {k}_{j} ← {g}_{2}^{\text{?}} for j = ℓ , … , ℓ - 1.$$

$$\text{?} \text{indicates text missing or illegible when filed}$$

It then recovers the message as

$$m ← c \text{?} {H}_{1} ( e ( {k}_{0} , u ) / {\prod }_{j = 1}^{ℓ - 1} e {H}^{0 ( ( {id}_{1} , … , {id}_{j + 1} ) ) , {k}_{j} )} ) .$$

$$\text{?} \text{indicates text missing or illegible when filed}$$

Multiple ciphertexts encrypted to the same identity vector (id₁, . . . , [symbol] ) can be decrypted using the same key (k₀, . . . , [symbol] ).

To generate a decryption key share for ciphertext c=(c, u, u, u ₂, . . . , [symbol] ) encrypted to a recipient public key rpk=(rpk₁,rpk₂), decryption node i first verifies the zero-knowledge proof in the ciphertext using Equations (9-11). If this fails, decryption node i aborts, otherwise, it chooses rᵢ←_{$}Zq and creates an encrypted ciphertext key share eckᵢ=(i,vᵢ,dᵢ) as

$${v}_{i} ← {g}_{2}^{\text{?}} , {d}_{i} ← {rpk}_{2}^{\text{?}} \cdot {u}^{\text{?}} .$$

$$\text{?} \text{indicates text missing or illegible when filed}$$

To verify an encrypted decryption share eckᵢ=(i,vᵢ,dᵢ) for ciphertext c=(c, u, u, u ₂, . . . , [symbol] ) and identity ((id₁, . . . , [symbol] )) under recipient public key rpk=(rpk₁,rpk₂), one checks that e(g₁,dᵢ)=e(rpk₁,vᵢ)·e(h_{1,i},u).

A set of t valid encrypted ciphertext key shares {eckᵢ: i∈S} for S⊆{1, . . . , n}, |S|=t, can be aggregated into a compact encrypted decryption eck=(v,d) as

$$v ← {Y}_{i}^{v} Λ i , S ( 0 )$$

$$i ∈ S d ← Y d Λ i , S ( 0 ) .$$

$$i ∈ S$$

TABLE 1

| scheme | independent | well-structured |
|---|---|---|
| tPKE | b(2t − 1) | b(2t − 1) |
| dtIBE | b(2t − 1) | 2t − 1 |
| vetDH2 | bt | bt |
| avetDH2 | b | b |
| dvetHIBE | b | 1 |

In Table 1, the number of decryption key components required for a request involving a batch of b ciphertexts for the different encryption schemes described in this section is shown. The b ciphertexts are “well-structured” if they are all encrypted to (descendants of) the same identity; they are “independent” otherwise.

An (aggregated) encrypted ciphertext key eck=(v,d) can be verified to contain a valid encryption pad for ciphertext c=(c, u, u, u ₂, . . . , [symbol] ) encrypted under rpk=(rpk₁,rpk₂) by checking that

$$e ( {g}_{1} , d ) = e ( {rpk}_{1} , v ) \cdot e ( {h}_{1 , 0} , u ) .$$

To decrypt a ciphertext c=(c, u, u, u ₂, . . . , [symbol] ) for identity (id₁, . . . , [symbol] ) using an encrypted ciphertext key eck=(v,d), the recipient first verifies the zero-knowledge proof in the ciphertext using Equations (9-11). If that fails, the recipient aborts, otherwise it recovers the encrypted message as

$$m ← c ⊕ e {H}^{1 ( ( i {d}_{1} ) ) , d / {v}^{\text{?}} )} .$$

$$\text{?} \text{indicates text missing or illegible when filed}$$

A number of implementations have been described. Nevertheless, it will be understood that various modifications may be made without departing from the spirit and scope of the disclosure. Accordingly, other implementations are within the scope of the following claims.

1. A confidential computing system, comprising:
a plurality of decryption nodes configured to collectively hold shares of a master secret key for a threshold encryption scheme;
a plurality of oracle nodes configured to authenticate computation requests and assign the computation requests to compute enclaves;
at least one compute enclave, each compute enclave comprising a trusted execution environment configured to execute computations on encrypted data;
wherein the plurality of decryption nodes are configured to generate encrypted decryption key shares for assigned compute enclaves based on encrypted inputs in the computation requests, such that each compute enclave receives only decryption key shares necessary to decrypt encrypted inputs assigned to that compute enclave.

2. The confidential computing system of claim 1, wherein the plurality of decryption nodes are configured to perform proactive re-sharing of the master secret key shares at regular intervals to prevent accumulation of compromised shares over time.

3. The confidential computing system of claim 1, wherein each compute enclave is configured to generate a fresh public-private key pair for each computation request to enable forward-secure encryption of the encrypted decryption key shares.

4. The confidential computing system of claim 3, wherein the plurality of decryption nodes are configured to encrypt the decryption key shares using the fresh public key of the assigned compute enclave.

5. The confidential computing system of claim 1, wherein the plurality of oracle nodes are configured to assign computation requests to compute enclaves based on a consensus mechanism requiring a threshold number of oracle nodes to agree on the assignment.

6. The confidential computing system of claim 1, wherein the encrypted inputs include associated data that binds each encrypted input to a specific application or decryption policy to prevent unauthorized decryption outside an intended context.

7. The confidential computing system of claim 6, wherein the plurality of decryption nodes are configured to verify the associated data before generating the encrypted decryption key shares to ensure compliance with the decryption policy.

8. The confidential computing system of claim 1, wherein the plurality of oracle nodes are configured to verify attestations from the compute enclaves and provide attested responses.

9. A method for confidential computing, comprising:
receiving a computation request comprising encrypted inputs and a computation algorithm;
authenticating the computation request using a plurality of oracle nodes;
assigning the computation request to at least one compute enclave comprising a trusted execution environment;
generating, by a plurality of decryption nodes holding shares of a master secret key, encrypted decryption key shares for the at least one assigned compute enclave, wherein the encrypted decryption key shares enable decryption of only the encrypted inputs assigned to the at least one compute enclave;
executing the computation algorithm on decrypted inputs within the trusted execution environment of the at least one compute enclave; and
generating an attested response from the at least one compute enclave.

10. The method of claim 9, further comprising a step of performing proactive re-sharing of the master secret key shares among the plurality of decryption nodes at regular intervals.

11. The method of claim 9, further comprising a step of generating a fresh public-private key pair at the at least one compute enclave for the computation request to enable forward-secure encryption.

12. The method of claim 11, wherein generating the encrypted decryption key shares comprises encrypting the decryption key shares using the fresh public key of the at least one assigned compute enclave.

13. The method of claim 9, wherein authenticating the computation request comprises reaching consensus among a threshold number of the plurality of oracle nodes before assigning the computation request.

14. The method of claim 9, wherein the encrypted inputs include associated data that binds each encrypted input to a specific application or decryption policy, and further comprising a step of verifying the associated data before generating the encrypted decryption key shares.

15. The method of claim 14, wherein verifying the associated data comprises ensuring compliance with the decryption policy to prevent unauthorized decryption outside an intended context.

16. A system for managing private token transactions, comprising:
A private token contract configured to maintain and update an encrypted balance table, the encrypted balance table storing encrypted account balances for a plurality of addresses across multiple token types;
a plurality of native token contracts configured to transmit deposit operations, wherein each deposit operation transfers tokens to the private token contract;
The private token contract being configured to:
receive transfer operations that specify source addresses, destination addresses, token types, and transfer amounts, wherein at least one of the source addresses, destination addresses, token types, and transfer amounts are in encrypted form; and
process the transfer operations by decreasing encrypted account balances for the source addresses and increasing encrypted account balances for the destination addresses in the encrypted balance table while maintaining encryption of the balance information.

17. The system of claim 16, wherein the private token contract is configured to process deposit operations by receiving tokens from the plurality of native token contracts and updating the encrypted balance table to reflect increased encrypted account balances for specified recipient addresses.

18. The system of claim 17, wherein the private token contract is configured to process withdraw operations by decreasing encrypted account balances in the encrypted balance table and transferring corresponding token amounts from the private token contract to caller addresses in the plurality of native token contracts.

19. The system of claim 16, wherein the private token contract is configured to process balance inquiry operations by providing encrypted balance information for specified addresses and token types without revealing actual balance amounts.

20. The system of claim 16, wherein the private token contract is further configured to generate encrypted responses to balance inquiry operations without revealing actual balance amounts to unauthorized parties.

21. The system of claim 19, wherein the balance inquiry operations include encrypted viewing keys that enable authorized parties to decrypt balance information while maintaining confidentiality from unauthorized parties.

22. The system of claim 20, wherein the encrypted viewing keys are generated using a threshold encryption scheme that requires a minimum number of decryption nodes to collaborate in providing access to the encrypted balance information.

23. A method for managing private token transactions, comprising:
maintaining an encrypted balance table within a private token contract, the encrypted balance table storing encrypted account balances for a plurality of addresses across multiple token types;
receiving deposit operations from a plurality of native token contracts, wherein each deposit operation transfers tokens to the private token contract;
updating the encrypted balance table to reflect increased encrypted account balances for recipient addresses specified in the deposit operations;
receiving transfer operations that specify source addresses, destination addresses, token types, and transfer amounts, wherein at least one of the source addresses, destination addresses, token types, and transfer amounts are in encrypted form;
processing the transfer operations by decreasing encrypted account balances for the source addresses and increasing encrypted account balances for the destination addresses in the encrypted balance table while maintaining encryption of the balance information; and
generating encrypted responses to balance inquiry operations without revealing actual balance amounts to unauthorized parties.

24. A system for making anonymous transaction cost payments on a decentralized network, the system comprising:
an onchain relay contract;
a backer configured to fund the onchain relay contract, receive prepaid transaction cost fees from a user, transmit a guarantee statement, and a one time public key for the transaction to the user;
one or more decentralized searchers configured to receive the guarantee statement and the one time public key from the user, transmits the encrypted transaction, the guarantee statement, and the one time public key to the onchain relay contract;
wherein the onchain relay contract transmits the transaction to a private smart contract and sends the fee and commission to an address of the searcher's choice.
